(19) United States
(12) Patent Application Publication
(10) Pub. No.: US 2024/0364150 A1
(43) Pub. Date: Oct. 31, 2024

(54) Configuration an electrical machine with increased efficiency and reduced cost of active materials

(71) Applicants: Andrey Pulnikov, Villingen-Schwenningen (DE); Aleksandr Pulnikov, Villingen-Schwenningen (DE)

(72) Inventors: Andrey Pulnikov, Villingen-Schwenningen (DE); Aleksandr Pulnikov, Villingen-Schwenningen (DE)

(21) Appl. No.: 18/140,049

(22) Filed: Apr. 27, 2023

(51) Int. Cl. H02K 1/16; H02K 1/27; H02K 3/12

(52) U.S. Cl. CPC H02K 1/16; H02K 1/27; H02K 3/12

(57) ABSTRACT

This invention is related to rotating electrical machines. The proposed novel structure of electrical machines allows achieving higher efficiency, smooth operation and better use of active materials. The proposed structure is applicable to linear electrical machines, radial electrical machines with internal and external rotor and for axial electrical machines. Electrical machines made in accordance with the proposed structure can be used as motors or generators.

This application claims the benefit of U.S. Provisional Application No. U.S. 63/338,900, filed May 6, 2022.

### FIELD OF INVENTION

This invention is related to rotating electrical machines. The proposed novel structure of electrical machines allows achieving higher efficiency, smooth operation and better use of active materials. The proposed structure is applicable to linear electrical machines, radial electrical machines with internal and external rotor and for axial electrical machines. Electrical machines made in accordance with the proposed structure can be used as motors or generators.

### BACKGROUND OF THE INVENTION

There is a growing demand for electrical machines for industrial applications and in electric vehicles. Depending on the country, electric motors consume 45-70% of the generated power. So it is important to reduce losses in electrical machines, as it affects overall power consumption. Also, increased efficiency in electrical machines reduces their operational cost. Reducing losses in electrical machines simplifies their cooling and reduces losses and the cost of selected cooling systems.

Increased efficiency in electrical machines can be achieved through the use of permanent magnets. Permanent magnets are typically located on a rotating part of electrical machines and constitute a constant source of magnetic field. In order to achieve high power density in electrical machines, rare earth permanent magnets are typically applied, such as NdFeB and SmCo. Due to the growing demand for such magnets, their price is constantly increasing in recent years. Alternative materials, such as ferrites, have lower power density. For this reason such materials do not allow achieving high performance in conventional configurations of electrical machines. High cost of permanent magnets used in conventional high efficiency electrical machines elevates the price of such machines. So there is a search for configurations of electrical machines providing a better use of permanent magnets and, possibly, allowing application of weaker but more affordable magnet materials, such as, for instance, ferrite magnets.

Another common problem for electrical machines with permanent magnets is a presence of cogging torque. Cogging torque leads to noise and vibrations during operation of electrical machines. It also affects achievable positioning accuracy for electrical machines.

In this invention we propose a solution for mentioned problems and other related issues.

### SUMMARY OF THE INVENTION

In this invention we present an electrical machine having superior properties and better use of materials. This is achieved through application of certain configurations and establishment of specific relations between different dimensions.

### DESCRIPTION OF THE DRAWINGS

FIG. 1A schematic representation of an active part of an electrical machine with a continuous layer of magnets on the rotor, vertical borders between rotor magnets and 4 poles on the rotor for 2 poles on the stator (A—an electrical machine with tooth shoes as a part of the stator teeth, B—an electrical machine with a removable part containing the tooth shoes).

FIG. 2A schematic representation of an active part of an electrical machine with a continuous layer of magnets on the rotor, vertical borders between rotor magnets and 2 poles on the rotor for 2 poles on the stator.

FIG. 3A schematic representation of an active part of an electrical machine with a continuous layer of magnets on the rotor, triangular magnets with vertical direction of magnetization, trapezoidal magnets with horizontal direction of magnetization and 4 poles on the rotor for 2 poles on the stator.

FIG. 4A schematic representation of an active part of an electrical machine with a continuous layer of magnets on the rotor, triangular magnets with vertical direction of magnetization, trapezoidal magnets with horizontal direction of magnetization and 2 poles on the rotor for 2 poles on the stator.

FIG. 5A schematic representation of an active part of an electrical machine with a continuous layer of magnets on the rotor, triangular magnets with vertical direction of magnetization, triangular magnets with horizontal direction of magnetization and 4 poles on the rotor for 2 poles on the stator.

FIG. 6A schematic representation of an active part of an electrical machine with a continuous layer of magnets on the rotor, trapezoidal magnets with vertical direction of magnetization, trapezoidal magnets with horizontal direction of magnetization and 4 poles on the rotor for 2 poles on the stator.

FIG. 7A schematic representation of an active part of an electrical machine with a continuous layer of magnets on the rotor, a polar magnetization of rotor magnets and 4 poles on the rotor for 2 poles on the stator.

FIG. 8A schematic representation of an active part of an electrical machine with a discontinuous layer of vertically magnetized magnets on the rotor and 4 poles on the rotor for 2 poles on the stator.

FIG. 9A schematic representation of an active part of an electrical machine with a continuous layer of vertically magnetized magnets on the rotor and 4 poles on the rotor for 2 poles on the stator.

FIG. 10A schematic representation of an active part of an electrical machine with a discontinuous layer of vertically magnetized magnets on the rotor and 4 poles on the rotor for 2 poles on the stator and extension blocks of a soft magnetic material over magnets.

FIG. 11A schematic representation of an active part of an electrical machine with a continuous layer of vertically magnetized magnets on the rotor and 4 poles on the rotor for 2 poles on the stator and extension blocks of a soft magnetic material over magnets.

FIG. 12A schematic representation of an active part of an electrical machine with V-shaped magnets on the rotor and 4 poles on the rotor for 2 poles on the stator and extension blocks of a soft magnetic material over magnets.

FIG. 13A schematic representation of an active part of an electrical machine with horizontally magnetized magnets on the rotor and 4 poles on the rotor for 2 poles on the stator and extension blocks of a soft magnetic material between magnets.

FIG. 14A cross-section of an electrical machine with a continuous layer of magnets on an internal rotor, radial borders between rotor magnets and 12 poles on the rotor and 6 poles on the stator.

FIG. 15A cross-section of an electrical machine with a continuous layer of magnets on an internal rotor, radial borders between rotor magnets and 6 poles on the rotor and 6 poles on the stator.

FIG. 16 Assembly steps for an internal stack of a split stator of a radial electrical machine with an internal rotor (A—a lamination of a non-magnetic material with teeth connected by bridges, B—tooth laminations of a soft magnetic material, C—relative location of different laminations in an internal stack, D—assembled internal stack).

FIG. 17 Assembly steps for a split stator of a radial electrical machine with an internal rotor (A—a lamination of a stator yoke stack, B—assembled stator yoke stack, C—stator windings located on teeth of an internal stack, D—assembled split stator).

FIG. 18A cross-section of an electrical machine with an external rotor with a continuous layer of magnets on an external rotor, radial borders between rotor magnets and 12 poles on the rotor and 6 poles on the stator.

FIG. 19 Assembly steps for an outer stack of a split stator of a radial electrical machine with an external rotor (A—a lamination of a non-magnetic material with tooth shoes connected by bridges, B—tooth shoe laminations of a soft magnetic metal, C—relative location of different laminations in an outer stack, D—assembled outer stack).

FIG. 20 Assembly steps for a split stator of a radial electrical machine with an external rotor (A—a lamination of an internal stack, B—assembled internal stack, C—stator windings located on teeth of the internal stack, D—assembled split stator).

FIG. 21A structure of an active part of an axial electrical machine with a continuous layer of magnets on an axial rotor, radial borders between rotor magnets and 12 poles on the rotor and 6 poles on the stator (A—a stator core, B—the stator core with stator winding, C—rotor magnets of the rotor, D—stator with winding and a rotor).

FIG. 22A structure of a 6 pole rotor with a discontinuous layer of vertically magnetized magnets and extension blocks over the magnets for a radial electrical machine with an internal rotor (A—a lamination of a non-magnetic material with impressions and slots for magnets, B—laminations of extension blocks and a lamination of a rotor core of a soft magnetic material with impressions, C—relative location of different laminations in a rotor stack, D—assembled rotor).

FIG. 23A structure of a 6 pole rotor with V-shaped magnets and extension blocks over the magnets for a radial electrical machine with an internal rotor (A—a lamination of a non-magnetic material with slots for magnets and impressions, B—laminations of extension blocks and a lamination of a rotor core of a soft magnetic material with impressions, C—relative location of different laminations in a rotor stack, D—assembled rotor).

FIG. 24A structure of a 6 pole rotor with horizontally magnetized magnets and extension blocks between the magnets for a radial electrical machine with an internal rotor (A—a lamination of a non-magnetic material with slots for magnets and impressions, B—laminations of extension blocks of a soft magnetic metal with impressions, C—relative location of different laminations in a rotor stack, D—assembled rotor).

FIG. 25A schematic representation of an active part of an electrical machine with a stator comprised of separate teeth and with two rotors, continuous layers of magnets on each rotor, vertical borders between rotor magnets and 4 poles on the rotors for 2 poles on the stator.

FIG. 26A structure of an active part of an axial electrical machine with a stator comprised of separate teeth and with two rotors, continuous layers of magnets on each rotor, radial borders between rotor magnets and 12 poles on the rotors and 6 poles on the stator (A—separate teeth of a stator core, B—the stator core with stator winding, C—rotor magnets of the rotors, D—the stator with winding and two rotors).

FIG. 27A structure of a 6 pole stator for a radial electrical machine with two rotors (A—a lamination of a non-magnetic material with internal tooth shoes connected by bridges, B—tooth laminations of a soft magnetic metal, C—relative location of different laminations in a stator stack, D—assembled stator stack).

FIG. 28A schematic representation of an active part of an electrical machine with a stator, straight teeth in the stator core, and with a rotor, a continuous layers of magnets on the rotor, vertical borders between rotor magnets and 4 poles on the rotor for 2 poles on the stator.

FIG. 29A schematic representation of an active part of an electrical machine with a stator, straight teeth in the stator core, coils of the stator winding on uneven stator teeth, and with a rotor, a continuous layer of magnets on the rotor, vertical borders between rotor magnets and 8 poles on the rotor for 4 poles on the stator.

FIG. 30A schematic representation of an active part of an electrical machine with a stator, coils of the stator winding on uneven stator teeth having tooth shoes, even straight stator teeth without stator winding, and with a rotor, a continuous layer of magnets on the rotor, vertical borders between rotor magnets and 8 poles on the rotor for 4 poles on the stator.

FIG. 31A schematic representation of an active part of an electrical machine with a stator, coils of the stator winding on uneven stator teeth having tooth shoes, even stator teeth without stator winding also having tooth shoes, and with a rotor, a continuous layer of magnets on the rotor, vertical borders between rotor magnets and 8 poles on the rotor for 4 poles on the stator.

FIG. 32 Assembly steps for a stator of a radial electrical machine with an internal rotor, a stator core with straight teeth, trapezoidal coils of the stator winding on uneven teeth and uniform coils of the stator winding on even teeth (A—a stator core with straight teeth, B—the stator core with the trapezoidal coils of the stator winding installed on the uneven teeth of the stator core, C—the stator core with the uniform coils of the stator winding installed on the even teeth of the stator core, D—a cross-section of the active part of the electrical machine).

FIG. 33 Assembly steps for a stator of a radial electrical machine with an internal rotor, a stator core with straight teeth, the trapezoidal coils of the stator winding wound on the uneven teeth and the uniform coils of the stator winding inserted on the even teeth (A—a stator core with straight teeth and with winding holders for trapezoidal coils of the stator winding, B—the stator core with the trapezoidal coils of the stator winding wound on the uneven teeth of the stator core, C—the stator core with the uniform coils of the stator winding installed on the even teeth of the stator core, D—a cross-section of the active part of the electrical machine).

FIG. 34 Assembly steps for a stator of a radial electrical machine with an internal rotor, a stator core with straight uneven teeth, coils of the stator winding on uneven teeth of the stator core and trapezoidal even teeth (A—a stator core with straight uneven teeth, B—the stator core with coils of the stator winding being installed on uneven teeth of the stator core and fixed by slot wedges, C—the stator core with a complete stator winding, D—a cross-section of the active part of the electrical machine).

FIG. 35 Assembly steps for a stator of a radial electrical machine with an internal rotor, a stator core with straight uneven teeth, coils of the stator winding on uneven teeth of the stator core and trapezoidal even teeth and composite slot wedges (A—a stator core, B—a composite slot wedge, C—the stator core with installed coils of the stator winding and composite slot wedges being inserted, D—a cross-section of the active part of the electrical machine).

FIG. 36 Assembly steps for a stator of a radial electrical machine with an internal rotor, a stator core with straight uneven teeth, coils of the stator winding on uneven teeth of the stator core and non-magnetic slot wedges (A—a stator core with straight uneven teeth, B—a non-magnetic slot wedge, C—the stator core with installed coils of the stator winding and non-magnetic slot wedges being inserted, D—a cross-section of the active part of the electrical machine).

FIG. 37 Assembly steps for a stator of a radial electrical machine with an internal rotor, a stator core composed of two parts, wherein the first part is composed of stator yoke and stator teeth and the second part is a removable part containing tooth shoes (A—a stator core with stator yoke and stator teeth, B—installation of the stator winding, C—a removable part with the tooth shoes, D—insertion of the removable part into the stator, E—a completed active part of the machine).

### DETAILED DESCRIPTION OF THE INVENTION

In the proposed invention simplified rotor and stator configurations are presented. Also, a number of relations is defined between selected rotor and stator dimensions. Electrical machines built in accordance with proposed configurations and following suggested relations have superior properties, such as increased efficiency, very low torque ripple, sinusoidal induced voltage in stator windings. Such machines have smooth operation and improved manufacturability. The proposed invention is suitable for linear electrical machines and for rotating electrical machines including radial electrical machines with internal and with external rotor and for axial electrical machines. An electrical machine can be a motor or a generator.

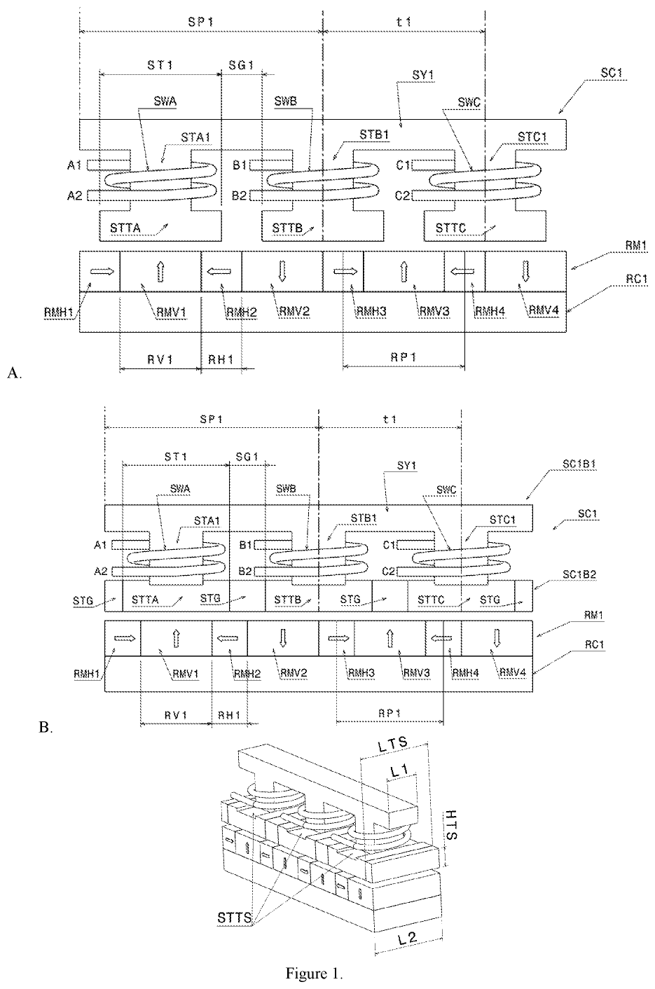

A schematic representation of an active part of an electrical machine is demonstrated in FIG. 1. This schematic representation refers to rotating electrical machines with internal or external rotors, to axial electrical machines and to linear electrical machines. The electrical machine is comprised of a stator with an electrical winding and a rotor with permanent magnets. The stator is separated from the rotor by a non-magnetic gap, which is in general case an air gap. A stator core is indicated as SC1 and is made of a soft magnetic material. The stator core is comprised of a yoke SY1 and three teeth STA1, STB1 and STC1 with tooth shoes indicated as STTA, STTB and STTC accordingly. On each stator tooth there is a concentrated winding. The concentrated windings are indicated as SWA, SWB and SWC with winding ends indicated as A1 and A2, B1 and B2 and C1 and C2 accordingly. The width of the stator tooth shoes at the gap with a rotor is indicated as ST1. The width of the space between neighboring stator tooth shoes at the gap is indicated as SG1. This space between neighboring stator tooth shoes is called a slot opening. The stator windings form a three-phase system. The electric currents in the three-phase stator winding shown in FIG. 1 produce magnetic field having two poles. There are four magnetic poles on the rotor, according to FIG. 1. The distance between the axis of neighboring teeth is called a tooth division of stator and is denoted as t1 and is equal to t1=ST1+SG1. The tooth division of a stator for linear electrical machines equals t1=LS1/Ns, where LS1 is the stator length along the air gap and Ns is a number of slots (or teeth) of the stator. The tooth division of a stator for rotating electrical machines equals t1=360°/Ns, where Ns is a number of slots (or teeth) of the stator. The pole length (or pole division) of the stator is denoted as SP1 in FIG. 1. The pole division of a stator for linear electrical machines equals SP1=LS1/Np1, where LS1 is the stator length along the air gap and Np1 is a total number of poles of the stator. The pole division of a stator for rotating electrical machines equals SP1=360°/Np1, where Np1 is a total number of poles of the stator. According to FIG. 1, 3 teeth with winding create two magnetic poles, therefore 3*t1=2*SP1, SP1=3/2*t1 or SP1=3/2*(ST1+SG1). The pole length (or pole division) of the rotor is indicated as RP1. The pole division of a rotor for linear electrical machines equals RP1=LS2/Np2, where LS2=LS1 is the rotor length along the air gap and Np2 is a total number of poles of the rotor. The pole division of a rotor for rotating electrical machines equals RP1=360°/Np2, where Np2 is a total number of poles of the rotor. According to FIG. 1, the number of magnetic poles of the rotor is two times larger than the number of poles of the stator: SP1=2*RP1. The tooth division of the stator equals t1=⅔*SP1=4/3*RP1. The width of a stator tooth shoe ST1 equals ST1=t1−SG1=⅔*SP1−SG1 or ST1=4/3*RP1−SG1. The slot opening of the stator SG1 can have any value from the following range: 1/12*SP1<=SG1<=¼*SP1 or ⅙*RP1<=SG1<=½*RP1.

The rotor is comprised of a continuous layer of permanent magnets RM1 and a rotor core RC1 made of a soft magnetic material. The permanent magnets represent separate pieces. A direction normal to the gap is further denoted as a vertical direction. In rotating electrical machines with a radial gap, which will be further referred to as radial electrical machines, this direction would be radial. In electrical machines with axial air gap, which will be further referred to as axial electrical machines, this direction would be axial. A direction along the gap is further indicated as a horizontal direction. In radial and axial electrical machines this direction would also be tangential. Magnetization directions in the magnets are shown by arrows. The magnets having a vertical magnetization direction are indicated in FIG. 1 as RMV1, RMV2, RMV3 and RMV4. The magnetization direction in these magnets alternates. The magnets RMV1 and RMV3 are magnetized upwards and the magnets RMV2 and RMV4 are magnetized downwards. The magnets having a horizontal magnetization direction are indicated in FIG. 1 as RMH1, RMH2, RMH3 and RMH4. The magnetization direction in these magnets also alternates. The magnets RMH1 and RMH3 are magnetized rightwards and the magnets RMH2 and RMH4 are magnetized leftwards. Horizontally magnetized magnets are located between corresponding vertically magnetized magnets, as demonstrated in FIG. 1. Neighboring rotor magnets in FIG. 1 are separated by vertical borders. This means that the width of the magnets at the gap is the same as the width of the magnets at the rotor core RC1. The width of vertically magnetized magnets at the gap is indicated as RV1. The width of horizontally magnetized magnets at the gap is indicated as RH1. The following dimensions are defined at the gap: the width of vertically and horizontally magnetized magnets, the pole division of the stator, the pole division of the rotor, the width of a stator tooth shoe of and the width of the slot opening. The specified dimensions are measured in linear dimensions for linear electrical machines and in mechanical or electrical degrees for rotating electrical machines. We shall use further any of the specified dimensions in such understanding. For example, in accordance with FIG. 1, the width of the slot opening SG1 equals the width of the horizontally magnetized magnets RH1 for linear electrical machines and for rotating electrical machines. The pole division of the rotor (or pole length of the rotor) equals RP1=RV1+RH1. For a real application in electrical machines a minimum width of horizontally magnetized magnets RH1 can be RH1=⅙*RP1. Then the width of vertically magnetized magnets RV1 will equal RV1=⅚*RP1=5*RH1. A maximum width of horizontally magnetized magnets RH1 for a real application in electrical machines can be RH1=⅔*RP1. Then the width of vertically magnetized magnets RV1 will equal RV1=⅓*RP1=½*RH1. Thus, the width of horizontally magnetized magnets RH1 can be in the following range ⅙*RP1<=RH1<=⅔*RP1 or 1/12*SP1<=RH1<=⅓*SP1. At the same time the width of vertically magnetized magnets RV1 has a value in the following range: ½*RH1<=RV1<=5*RH1. As it was noted in the previous paragraph, there are four magnetic poles on the rotor. So, the number of poles of the rotor in FIG. 1 is two times higher compared to the number of poles of the stator. This is a well-known fact, but the novelty is in relations between dimensions of the rotor magnets and dimensions of the tooth zone of the stator.

Investigations show, that maximum torque, created by an electrical motor, described in paragraphs [0008]-[0009] and demonstrated on the FIG. 1, at the same current in the winding and at the same air gap, is observed at the following geometrical dimensions of rotor magnets and geometrical dimensions of the tooth zone of the stator. The width of horizontally magnetized magnets RH1 in this case equals RH1=⅓*RP1, then the width of vertically magnetized magnets RV1 equals RV1=⅔*RP1, because RP1=RV1+RH1. The width of vertically magnetized magnets RV1 also equals to the double width of horizontally magnetized magnets at the gap, RV1=2*RH1. The width of tooth shoes of the stator ST1 must be equal to the pole division of the rotor RP1: ST1=RP1. The slot opening of the stator SG1 must be equal to the width of horizontally magnetized magnets RH1: SG1=RH1 and SG1=⅓*RP1. Then, ST1=RP1=RV1+RH1 or ST1=3*RH1=3*SG1, or SG1=⅓*ST1 and the width of horizontally magnetized magnets RH1 equals RH1=⅓*ST1. The pole division of the stator SP1 equals SP1=2*RP1=2*ST1 and equals also SP1=2*RV1+2*RH1=3*RV1.

The stator core SC1 in FIG. 1B consists of two separate parts: SC1B1 and SC1B2. The part SC1B1 is composed of a stator yoke SY1 and stator teeth STA1, STB1 and STC1. The part SC1B2 is a separate removable part. The part SC1B2 is composed of the soft magnetic tooth shoes STTA, STTB and STTC and non-magnetic intermediate parts STG. The tooth shoes STTA, STTB and STTC are made of a soft magnetic material with a preference for a soft magnetic composite, such as, for instance, Somaloy. The intermediate parts STG could be made of a non-magnetic metal, like aluminum or a non-magnetic stainless steel, a plastic, a ceramic or another non-magnetic material. The parts STG are used to connect the tooth shoes together and provide the solid removable part SC1B2. Therefore the parts STG are further referred as the fixing parts. The axial length of the part SC1B1 is equal to L1. The axial length of the tooth shoes SC1B2 is equal to LTS. The axial length of the rotor core RC1 and of the layer of permanent magnets RM1 is equal to L2. In general case, L1 is smaller than or equal to LTS and LTS is smaller than or equal to L2. If L2>=LTS>=L1, this allows concentrating magnetic field of the longer permanent magnets RM1 into the shorter stator core SC1B1. The amount of the magnetic field concentration is achieved by selecting appropriate ratio between L1 and L2. Practically, the concentration of the magnetic field enables the use of weaker, but substantially cheaper permanent magnets, such as, for example, ferrite magnets. Properties of electrical machines with concentration of magnetic field and cheap magnets come close to properties of electrical machines without concentration of magnetic field but with more powerful and expensive magnets, such as, for example, sintered NdFeB magnets or sintered SmCo magnets. The width of a stator tooth shoe ST1 in SC1B2 equals ST1=t1−SG1=⅔*SP1−SG1 or ST1=4/3*RP1−SG1. The slot opening SG1 between the tooth shoes in SC1B2 can have any value from the following range: 1/12*SP1<=SG1<=¼*SP1 or ⅙*RP1<=SG1<=½*RP1. Investigations show that the axial length LTS should not exceed L1 by more than 3 times: max (LTS)=3*L1. In case of a linear electrical machine the removable part SC1B2 has a shape of a parallelepiped and is fixed to the stator teeth using slots STTS. In case of a rotating electrical machine with inner or outer rotor and also in case of a rotating electrical machine with axial air gap, the removable part SC1B2 has a shape of a cylinder and is fixed to the stator using slots STTS. Another useful feature of the application of the removable part SC1B2 is a possibility of manufacturing coils of the stator winding outside the stator and installing these coils on corresponding stator teeth. If only this feature is required, then L1 can be equal to LTS: L1=LTS. Therefore the axial length of the tooth shoes LTS can have any value from the following range: L1<=LTS<=3*L1. The axial length of permanent magnets RM1 can have any value from the following range: L1<=L2<=3.5*L1. The height HTS of the tooth shoes STTA, STTB and STTC in SC1B2 is chosen from a condition that the maximal flux density in the tooth shoes does not exceed the knee point of the magnetization characteristic B(H) of the material of the tooth shoes. The concentration of magnetic field by such a manner is well known, but the novelty is in relations between dimensions of the rotor magnets and dimensions of the tooth zone of the stator and dimensions of the tooth shoes.

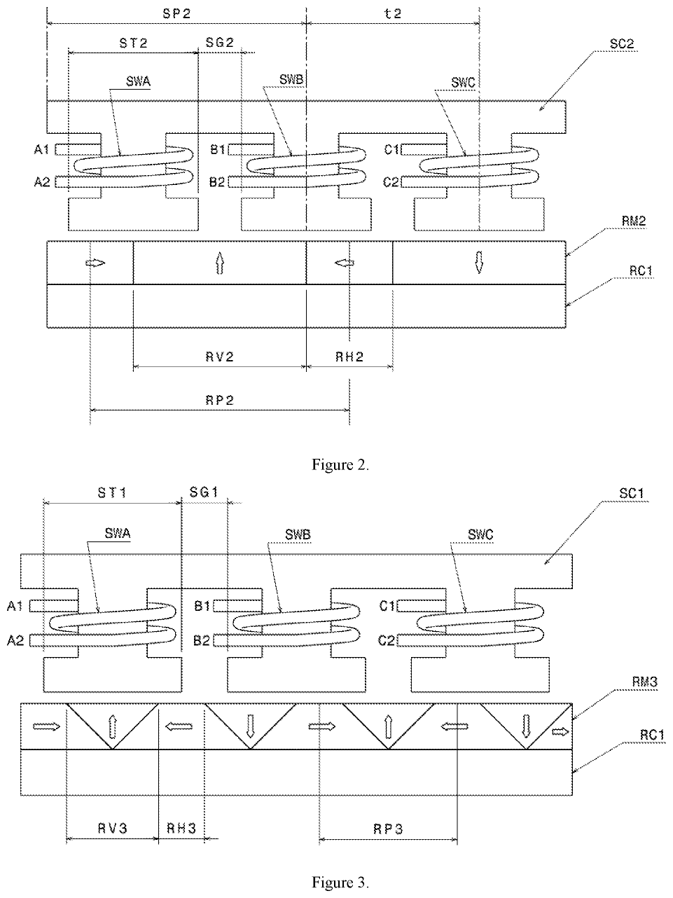

The number of poles on the rotor in FIG. 1 is two times higher compared to the number of poles on the stator. However, the proposed invention also allows that the number of poles on the rotor equals the number of poles on the stator. This is demonstrated in FIG. 2. This is a well-known fact, but the novelty is in relations between dimensions of the rotor magnets and dimensions of the tooth zone of the stator. The rotor in FIG. 2 is comprised of a continuous layer of permanent magnets RM2 and a rotor core RC1. As in FIG. 1, the rotor magnets are separated by vertical borders. The pole length (or pole division) on the rotor is indicated as RP2. Pole division of stator SP2-RP2. Tooth division of stator t2=⅔*SP2=⅔*RP2. The width of vertically magnetized magnets at the gap is indicated as RV2. The width of horizontally magnetized magnets at the gap is indicated as RH2. The width of the tooth shoes ST2 equals ST2=t2−SG2=⅔*SP2−SG2=⅔*RP2−SG2. The slot opening SG2 between the stator teeth is defined by the range 1/12*SP2<=SG2<=¼*SP2 or 1/12*RP2<=SG2<=¼*RP2. The pole division of the rotor equals RP2=RV2+RH2. The width of horizontally magnetized magnets RH2 is in the range: ⅙*RP2<=RH2<=⅔*RP2 or ⅙*SP2<=RH2<=⅔*SP2. The width of vertically magnetized magnets RV2 has value in the range: ½*RH2<=RV2<=5*RH2. In relation to the rotor configuration shown in FIG. 1 it can be stated that RV2−2*RV1, RH2=2*RH1, RP2=2*RP1. In this case the horizontally magnetized magnets have the width at the gap of ⅓ of the pole division of the rotor RH2=⅓*RP2, the vertically magnetized magnets have the width at the gap, which equals to double width of horizontally magnetized magnets RV2=2*RH2, the width of a tooth shoe of the stator at the gap equals to ½ of the pole division of the rotor ST2=½*RP2 and the slot opening of the stator at the gap equals to ½ of the width of the horizontally magnetized magnets SG2=½*RH2. The stator core SC2 on the FIG. 2 can also consist of two parts similar to FIG. 1B. The first part would be composed of the stator yoke and the stator teeth. The second part would be the separate removable part containing tooth shoes. The properties of the removable part are the same, as it was described in paragraph [0010].

The proposed invention also allows the use of magnets of triangular and trapezoidal shapes. In FIG. 3 a schematic representation is shown of an active part of an electrical machine with vertically magnetized magnets having a triangular shape and horizontally magnetized magnets having a trapezoidal shape. The rotor is comprised of a continuous layer of permanent magnets RM3 and a rotor core RC1. The width of vertically magnetized magnets at the gap is indicated as RV3. The width of horizontally magnetized magnets at the gap is indicated as RH3. The width of horizontally magnetized magnets at the rotor core RC1 equals the pole length RP3. The number of poles on the rotor is two times higher compared to the number of poles on the stator. Here as in case, described in paragraphs [0008]-[0009], the width of the stator tooth shoe ST1 equals ST1=t1−SG1=⅔*SP1−SG1 or ST1=4/3*RP3−SG1. The slot opening of the stator SG1 has a value in the following range: 1/12*SP1<=SG1<=¼*SP1 or ⅙*RP3<=SG1<=½*RP3. The width of horizontally magnetized magnets RH3 is in the range: ⅙*RP3<=RH3<=⅔*RP3 or 1/12*SP1<=RH3<=⅓*SP1. The width of vertically magnetized magnets RV3 has a value in the range: ½*RH3<=RV3<=5*RH3. In relation to the rotor configuration shown in FIG. 3, RH3=½*RV3 and RH3+RV3=ST1. So, the width of horizontally magnetized magnets at the gap equals a half of the width of vertically magnetized magnets. The pole length on the rotor is indicated as RP3. So, the pole length of the rotor at the air gap equals the sum of the widths of a vertically magnetized magnet and a horizontally magnetized magnet, and the pole length of the rotor at the air gap equals the width of a tooth shoe of the stator RV3+RH3=RP3=ST1. It is obvious that vertically magnetized magnets have the width at the gap of ⅔ of the pole length of the rotor: RV3=⅔*RP3.

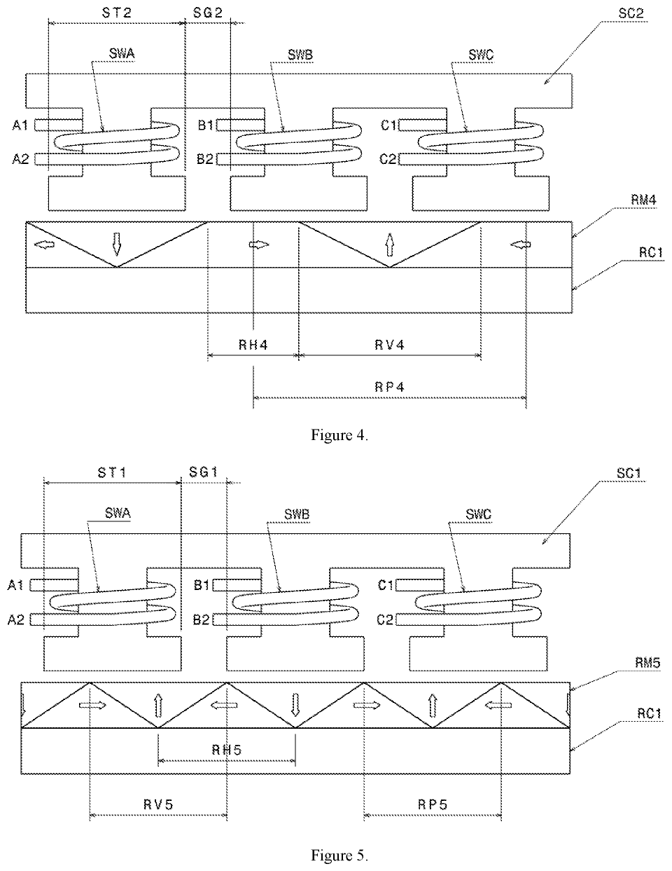

As demonstrated above, the number of rotor poles can be reduced down to the number of poles on the stator by doubling corresponding dimensions of the rotor magnets. Such a rotor configuration is shown in FIG. 4. The rotor is comprised of a continuous layer of permanent magnets RM4 and a rotor core RC1. The width of vertically magnetized magnets at the gap is indicated as RV4. The width of horizontally magnetized magnets at the gap is indicated as RH4. Here, as in case described in paragraph [0010], the width of the stator tooth shoe ST2 equals ST2=t2−SG2−⅔*SP2−SG2=⅔*RP4−SG2. The slot opening of stator SG2 has a value in the range: 1/12*SP2<=SG2<=¼*SP2 or 1/12*RP4<=SG2<=¼*RP4. The width of horizontally magnetized magnets RH4 is in the range: ⅙*RP4<=RH4<=⅔*RP4 or ⅙*SP2<=RH4<=⅔*SP2. The width of vertically magnetized magnets RV4 has a value in the range ½*RH4<=RV4<=5*RH4. In relation to the rotor configuration shown in FIG. 4, RH4=½*RV4. The pole length on the rotor is indicated as RP4. So RV4+RH4=RP4. The width of horizontally magnetized magnets at the rotor core RC1 equals the pole length RP4. Since RV4=RV2 and RH4=RH2, relations for the stator in FIG. 4 are the same as in FIG. 2. In relation to the rotor configuration shown in FIG. 3 it can be stated that RV4=2*RV3, RH4=2*RH3, RP4=2*RP3.

The proposed invention allows that all the rotor magnets are triangular. In FIG. 5 a schematic representation of an active part of an electrical machine is shown with vertically magnetized magnets having a triangular shape and horizontally magnetized magnets also having a triangular shape. The rotor is comprised of a continuous layer of permanent magnets RM5 and a rotor core RC1. The width of vertically magnetized magnets at the gap is indicated as RV5. The width of horizontally magnetized magnets at the rotor core RC1 is indicated as RH5, such that RH5=RV5. The pole length on the rotor is indicated as RP5. So RV5=RH5=RP5. The width of vertically magnetized magnets at the gap equals the pole length of the rotor. Here, as in case described in paragraphs [0008]-[0009], the width of the stator tooth shoe ST1 equals ST1=t1−SG1=⅔*SP1−SG1 or ST1=4/3*RP5−SG1. The slot opening of stator SG1 has a value in the range: 1/12*SP1<=SG1<=¼*SP1 or ⅙*RP5<=SG1<=½*RP5. The width of horizontally magnetized magnets RH5 is in the range ⅙*RP5<=RH5<=⅔*RP5 or 1/12*SP1<=RH5<=⅓*SP1. In relation to the rotor configuration shown in FIG. 5, RH5=RV5=ST1. The number of poles on the rotor is two times higher compared to the number of poles on the stator. However, as demonstrated above, this rotor configuration could also be used for the case when the rotor and the stator have equal number of poles. This could be achieved by doubling the distances RH5, RV5 and RP5 accordingly.

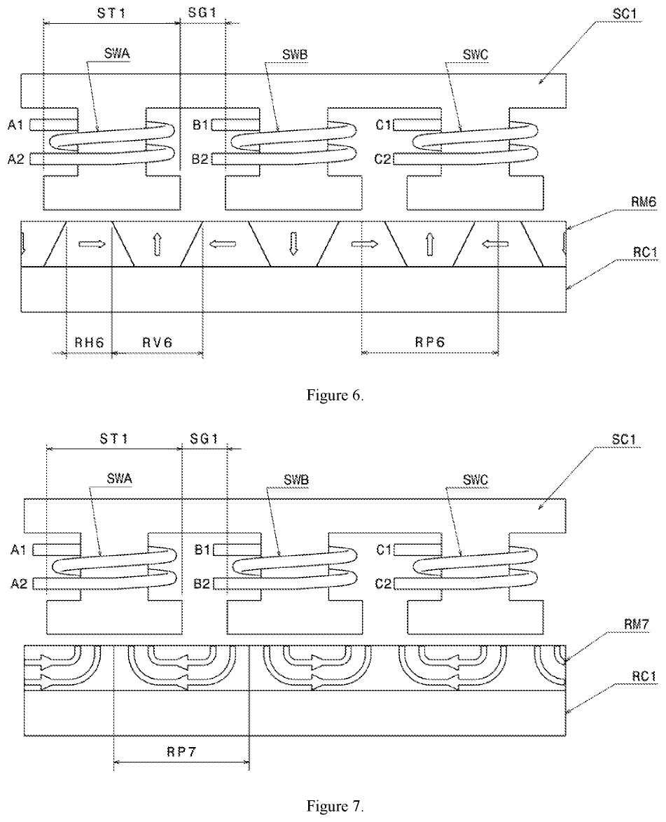

The proposed invention allows that all the rotor magnets are of a trapezoidal shape as demonstrated in FIG. 6. The rotor is comprised of a continuous layer of permanent magnets RM6 and a rotor core RC1. The width of vertically magnetized magnets at the gap is indicated as RV6. The width of horizontally magnetized magnets at the gap is indicated as RH6. Here, as in case described in paragraphs [0008]-[0009], the width of the stator tooth shoe ST1 equals ST1=t1−SG1=⅔*SP1−SG1 or ST1=4/3*RP6−SG1. The Slot Opening of stator SG1 has a value in the range: 1/12*SP1<=SG1<=¼*SP1 or ⅙*RP6<=SG1<=½*RP6. The width of horizontally magnetized magnets RH6 is in the range: ⅙*RP6<=RH6<=⅔*RP6 or 1/12*SP1<=RH6<=⅓*SP1. The width of vertically magnetized magnets RV6 is in the range: ½*RH6<=RV6<=5*RH6. In relation to the rotor configuration shown in FIG. 6, RH6=½*RV6. So, the width of horizontally magnetized magnets at the gap equals a half of the width of vertically magnetized magnets. The pole length on the rotor is indicated as RP6. So RV6+RH6=RP6=ST1. It is obvious that vertically magnetized magnets have the width at the gap of ⅔ of the pole length of the rotor: RV6=⅔*RP6. The width of vertically magnetized magnets at the core RC1 is smaller than RV6 and the width of horizontally magnetized magnets at the core RC1 is larger than RH6. The number of poles on the rotor is two times higher compared to the number of poles on the stator. However, as demonstrated above, this rotor configuration could also be used for the case when the rotor and the stator have equal number of poles. This could be achieved by doubling the distances RH6, RV6 and RP6 accordingly.

The proposed invention also allows a polar magnetization of magnets. Such magnetization is typically applied for isotropic magnets. However, some producers of permanent magnets apply polar magnetization also for anisotropic magnets. Some producers also call this magnetization as multi-pole magnetization. This magnetization is carried out using a special magnetization winding with a current impulse of several kiloamperes. As a result, local magnetization direction in a permanent magnet is in accordance with magnetic field lines, created by the current. In FIG. 7 the rotor is comprised of a continuous layer of permanent magnets RM7 with a polar magnetization and a rotor core RC1. The pole length on the rotor is indicated as RP7. The layer of permanent magnets is composed of separate pieces or represents a solid body. Here, as in case described in paragraphs [0008]-[0009], the width of the stator tooth shoe ST1 equals ST1=t1−SG1=⅔*SP1−SG1 or ST1=4/3*RP7−SG1. The slot opening of the stator SG1 has a value in the range: 1/12*SP1<=SG1<=¼*SP1 or ⅙*RP7<=SG1<=½*RP7. In relation to the rotor configuration shown in FIG. 7, the width of the stator tooth shoe equals the pole length of the rotor ST1=RP7. The number of poles on the rotor is two times higher compared to the number of poles on the stator. However, as demonstrated above, this rotor configuration could be used for the case when the rotor and the stator have equal number of poles. This could be achieved by doubling the pole length RP7 on the rotor. The layer RM7 could be composed of separate pieces of magnets providing a polar magnetization, as demonstrated in FIG. 7.

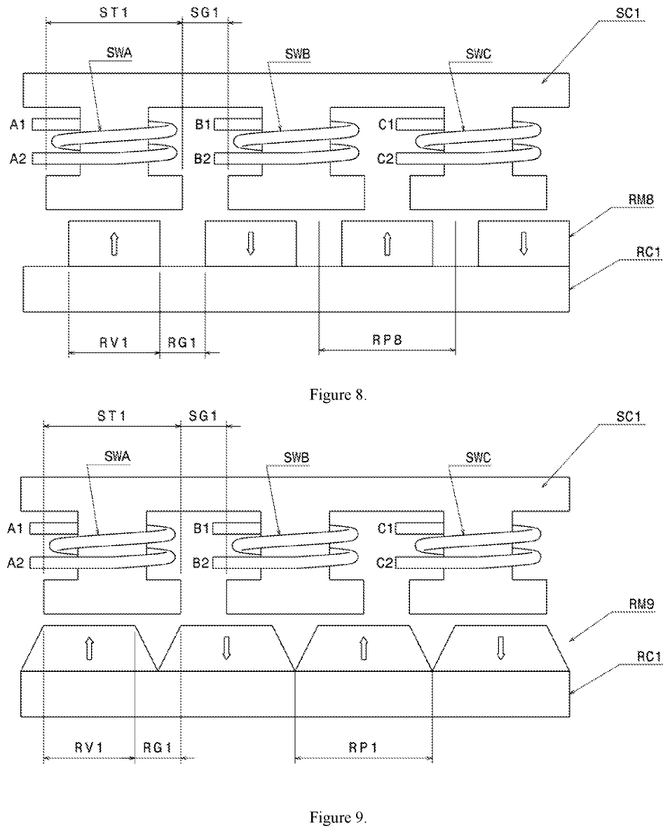

The proposed invention also allows the use of a discontinuous layer of magnets on the rotor as demonstrated in FIG. 8. The rotor in FIG. 8 is comprised of a discontinuous layer of permanent magnets RM8 and a rotor core RC1. The rotor configuration shown in FIG. 8 is similar to the one presented in FIG. 1, but with horizontally magnetized magnets omitted. So the width of vertically magnetized magnets in FIG. 8 is equal to RV1. The width of the space between magnets, indicated as RG1, is equal to RH1. The pole length on the rotor, indicated as RP8, is equal to RP1. Here, as in case described in paragraphs [0008]-[0009], the width of stator tooth shoe ST1 equals ST1=t1−SG1=⅔*SP1−SG1 or ST1=4/3*RP8−SG1. The slot opening of stator SG1 has a value in the range: 1/12*SP1<=SG1<=¼*SP1 or ⅙*RP8<=SG1<=½*RP8. The width of the space between magnets RG1 (in FIG. 8) equals to the width of horizontally magnetized magnets RH1 (in FIG. 1) and is in the range: ⅙*RP8<=RG1<=⅔*RP1 or 1/12*SP1<=RG1<=⅓*SP1. The width of vertically magnetized magnets RV1 has a value in the range: ½*RG1<=RV1<=5*RG1. In relation to the rotor configuration shown in FIG. 8, the width of space between magnets at the gap equals a half of the width of vertically magnetized magnets. So RV1+RG1=ST1=RP8. It is obvious that vertically magnetized magnets have the width at the gap of ⅔ of pole length of the rotor RV1=⅔*RP8. The number of poles on the rotor is two times higher compared to the number of poles on the stator. However, as demonstrated above, this rotor configuration could also be used for the case when the rotor and the stator have equal number of poles. This could be achieved by doubling the distances RV1, RG1 and RP8 accordingly.

For technological reasons it could be useful to maintain mechanical contact between magnets. Such a rotor configuration is demonstrated in FIG. 9. The rotor is comprised of a continuous layer of permanent magnets RM9 and a rotor core RC1. The shape of the magnets is trapezoidal. However, the width of vertically magnetized magnets at the gap is indicated as RV1. The width of the space between the nearest top corners of neighboring magnets, indicated as RG1, is equal to RH1. Thus, the width of the space between neighboring magnets changes from RG1 at the gap to zero at the surface of the rotor yoke RC1.

The width of vertically magnetized magnets at the rotor core RC1 varies from 0, as shown in FIG. 3, to RP1, as demonstrated in FIG. 9. The width of horizontal magnets at the rotor core RC1 varies from 0 and up to RP1, as demonstrated in FIG. 3. In rotor configurations presented in FIGS. 3, 4, 5, 6 and 7 the rotor core RC1 could be made of a non-magnetic material, because this would not have a substantial effect on the magnetic field provided by the rotor in the gap.

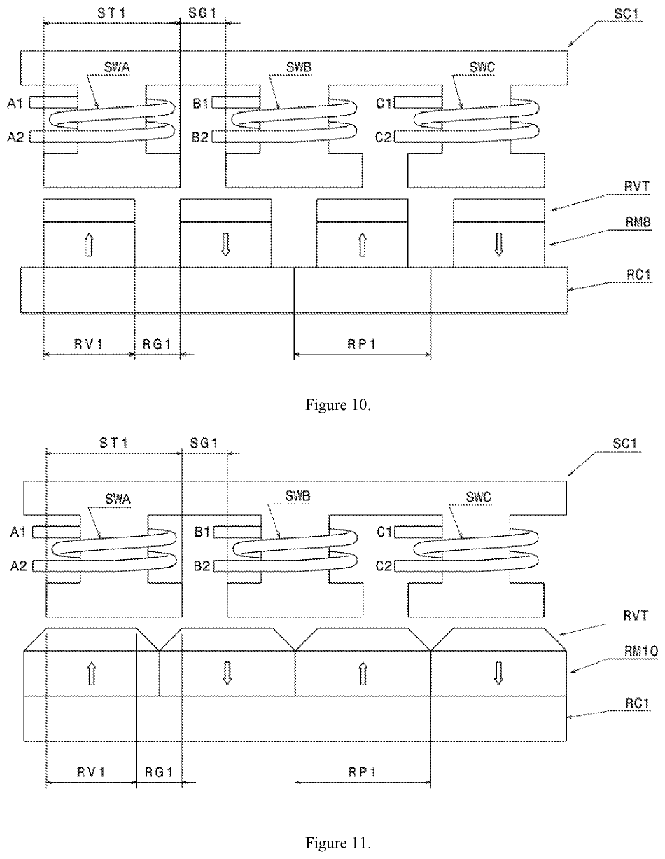

The proposed invention also allows to extend the rotor magnets towards the gap using an extension layer of extension blocks RVT of a soft magnetic material as demonstrated in FIG. 10. The rotor in FIG. 10 is comprised of a discontinuous layer of vertically magnetized permanent magnets RM8, a rotor core RC1 and an extension layer of extension blocks RVT of a soft magnetic material over the layer of magnets RM8. The width of the magnets at the extension blocks RVT is equal to RV1 and the width of the space between magnets at the extension blocks is equal to RG1. The width of the extension blocks at the gap is equal to RV1 and the width of the space between neighboring extension blocks at the gap is equal to RG1. The extension blocks RVT serve for transition of magnetic flux from magnets into the gap. With respect to magnetic field produced by the rotor in the gap, the rotor in FIG. 10 is similar to the rotor in FIG. 8.

The width of the magnets at the extension layer can be increased. This is demonstrated in FIG. 11. A continuous layer of vertically magnetized magnets RM10 is composed of magnets with a width equal to the pole length RP1 of the rotor. The width of the extension blocks RVT at the magnets is equal to RP1 in FIG. 11. The width of the extension blocks RVT at the gap is equal to RV1 and the width of the space between neighboring extension blocks at the gap is equal to RG1. With respect to magnetic field produced by the rotor in the gap, the rotors shown in FIG. 8, FIG. 9, FIG. 10 and FIG. 11 are practically equivalent.

As demonstrated in FIG. 10 and FIG. 11, the width of the magnets at the extension layer can vary from ⅔ of the rotor pole length to the rotor pole length. The width of the extension blocks at the gap is equal to ⅔ of the rotor pole length. The width of the extension blocks at the magnets can vary from ⅔ of the rotor pole length to the rotor pole length.

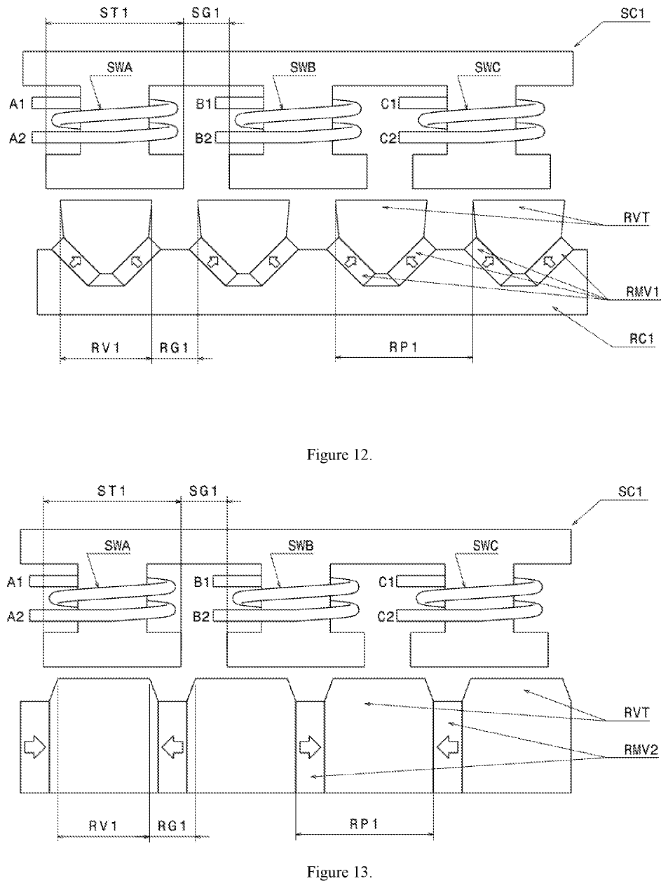

Since magnetic field in the gap created by the rotor is generally defined by the width of extension blocks in the gap and by the width of the space between extension blocks, different orientations of permanent magnets in the rotor are possible. In FIG. 12 rotor magnets RMV1 are located in a V-shape between the rotor core RC1 and extension blocks RVT. The width of extension blocks at the gap is RV1 and the width of space at the gap between extension blocks is RG1.

Extension blocks could be used for guiding magnetic flux of the magnets towards the gap, as shown earlier in FIG. 10 and FIG. 11. Extension blocks could also be used for turning magnetic flux from magnets towards the air gap and for concentrating the magnetic flux from magnets. This is clearly demonstrated in FIG. 12 and in FIG. 13. In FIG. 13 the magnetic flux from horizontally magnetized magnets RMV2 turns towards the gap in extension blocks RVT. However, the width of extension blocks RVT at the gap is equal to RV1. The space between extension blocks at the gap is equal to RG1. So magnetic field generated in the gap by rotors shown in FIG. 10, FIG. 11, FIG. 12 and FIG. 13 is equivalent to magnetic field generated in the gap, for instance, by the rotor presented in FIG. 1. In this respect rotors shown in FIGS. 1, 3, 5-13 are equivalent to each other.

In FIGS. 1, 3, 5-13 there are fragments of an electrical machine presented with properties described in paragraphs [0008]-[0010], [0012], [0014]-[0024]. Electrical machines described in earlier paragraphs may include an arbitrary number of such fragments. The number of stator teeth Ns is defined as Ns=3*p, where p is the number of pole pairs of the stator and p is any positive integer number. The number of stator poles Np1 is equal to 2*p and the number of rotor poles Np2 is equal to 4*p.

In FIGS. 2 and 4 there are fragments of an electrical machine presented with properties described in paragraphs [0011] and [0013]. Electrical machines described in earlier paragraphs may include an arbitrary number of such fragments. The number of stator teeth Ns is defined as Ns=3*p, where p is the number of pole pairs of the stator and p is any positive integer number. The number of stator poles Np1 is equal to 2*p and the number of rotor poles Np2 is equal to 2*p.

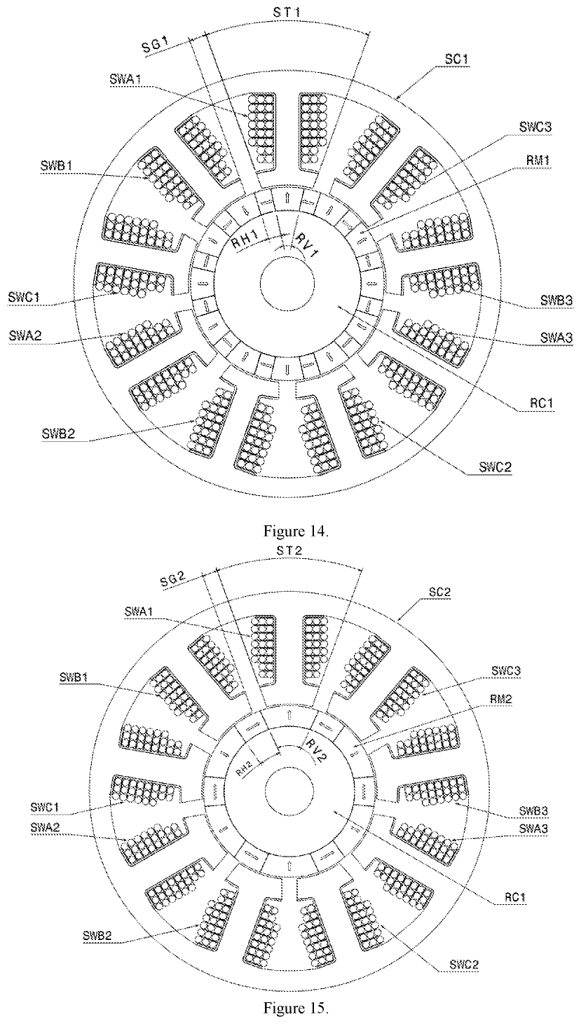

So all the configurations demonstrated in FIGS. 1-13 can be used as a basis for building active parts of electrical machines. In FIG. 14 a radial rotating electrical machine with an internal rotor is shown with an active part in accordance with the configuration presented in FIG. 1. The stator is comprised of a core SC1 with nine teeth and nine concentric windings SWA1, SWB1, SWC1, SWA2, SWB2, SWC2, SWA3, SWB3, SWC3. Windings SWA1, SWA2, SWA3 belong to phase A. Windings SWB1, SWB2, SWB3 belong to phase B. Windings SWC1, SWC2, SWC3 belong to phase C. So the stator has 6 poles. The width of the stator tooth shoes at the gap of the machine is ST1. The width of the space between tooth shoes at the gap of the machine is SG1. Also, in accordance with the configuration presented in FIG. 1, the width of vertically magnetized magnets is RV1 and the width of tangentially magnetized magnets is RH1. Since this is a radial electrical machine, the dimensions ST1, SG1, RV1 and RH1 are defined as sectors and measured in mechanical or electrical degrees for the stator. In accordance with relations defined above, ST1=90 el. deg., SG1=30 el. deg., RV1=60 el. deg., RH1=30 el. deg. There are 12 poles on the rotor. For radial rotating electrical machines designed according to FIG. 14, the magnets with tangential magnetization can also have parallel walls.

In FIG. 15 a radial rotating electrical machine with an internal rotor is shown with an active part in accordance with the configuration presented in FIG. 2. The width of vertically magnetized magnets is RV2 and the width of tangentially magnetized magnets is RH2. Since this is a radial electrical machine, the dimensions RV2 and RH2 are defined in mechanical or electrical degrees for the stator. In accordance with relations defined above, RV2=120 el. deg., RH2=60 el. deg. There are 6 poles on the rotor. For radial rotating electrical machines designed according to FIG. 15, the magnets with tangential magnetization can also have parallel walls.

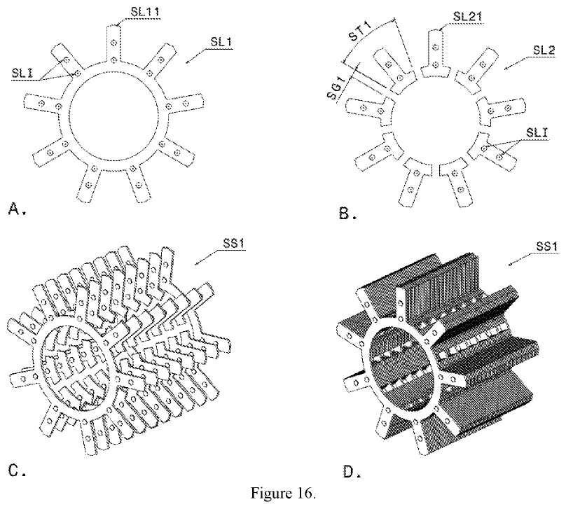

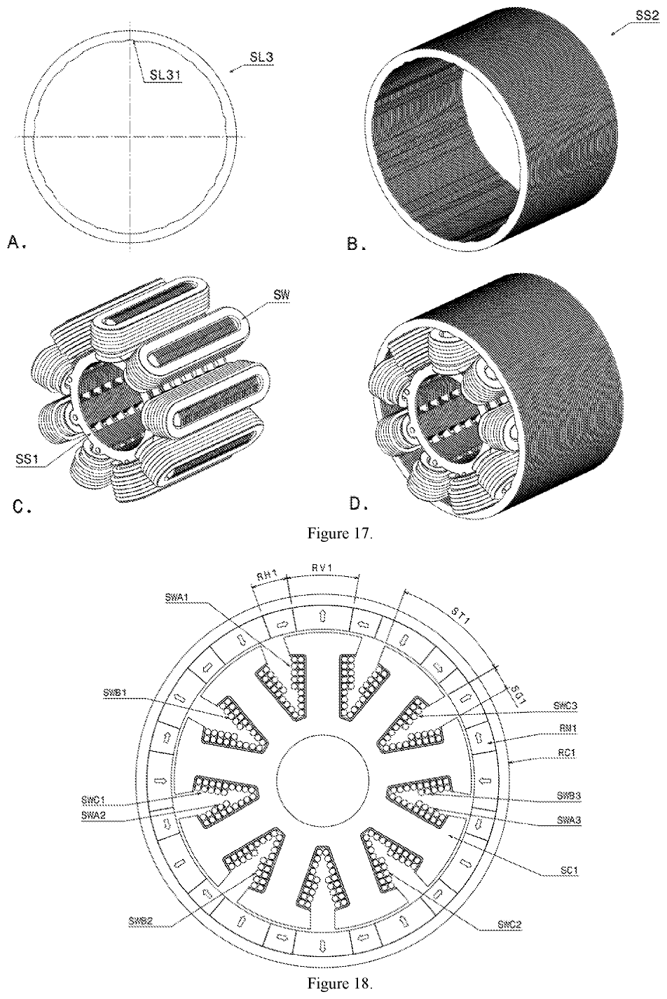

The configurations for active parts proposed in this invention are suitable both for small and for large motors. Stator windings of large motors should preferably be wound with a thick rigid wire. So it would be easier to use a split stator. Manufacturing steps for an internal stack of a split stator are demonstrated in FIG. 16. In FIG. 16A a lamination SL1 with bridges between teeth is shown. The tops of the teeth SL11 have a triangular shape for further aligning in a stator yoke and for the torque transfer. Also, a few impressions SL1 are provided for each tooth. In FIG. 16B a set of tooth laminations SL2 is shown. The width of tooth shoes at the inner surface is equal to ST1 and the width of the space between teeth at the inner surface in an assembled internal stack is equal to SG1. Each tooth is also provided with impressions SL1. The tops of the teeth SL21 also have a triangular shape equivalent to SL11. In FIG. 16C a relative orientation of laminations SL1 and SL2 within the inner stator stack SS1 is shown. Impressions SL1 on the laminations SL1 and SL2 would help maintaining their relative position. Laminations SL1 provide mechanical integrity to the stack SS1. In order to avoid excessive flux leakage through bridges in SL1 laminations, these laminations could be cut from a non-magnetic material such as, for instance, austenitic stainless steel or another non-magnetic metal, while laminations SL2 could be made of a soft magnetic metal such as, for instance, electrical steel. In FIG. 16D a completed internal stator stack SS1 is shown. The stack SS1 could additionally be held together by welding. In FIG. 17A a lamination SL3 of a stator yoke stack is shown. This lamination has slots SL31 of a triangular shape corresponding to SL11 and SL21 demonstrated in FIG. 16A and FIG. 16B. In FIG. 17B a completed stator yoke stack SS2 is shown with slots SL31 of the neighboring laminations aligned. In the meantime concentric stator windings SW could be wound separately and located on the teeth of the inner stack SS1, as shown in FIG. 17C. The stator winding SW can also be wound directly on the teeth of the inner stack SS1 also by means of a flyer method. The inner stack SS1 with the stator winding SW could then be inserted into the yoke stack SS2, as shown in FIG. 17D. The yoke stack SS2 could, for instance, be preheated prior to insertion of the inner stack SS1 with the stator winding SW.

In FIG. 18 a radial electrical machine with an external rotor is shown with an active part in accordance with the configuration presented in FIG. 1. With respect to the number of poles and relations for the rotor and the stator this machine is similar to the one shown earlier in FIG. 14. For radial rotating electrical machines designed according to FIG. 18, the magnets with tangential magnetization can also have parallel walls.

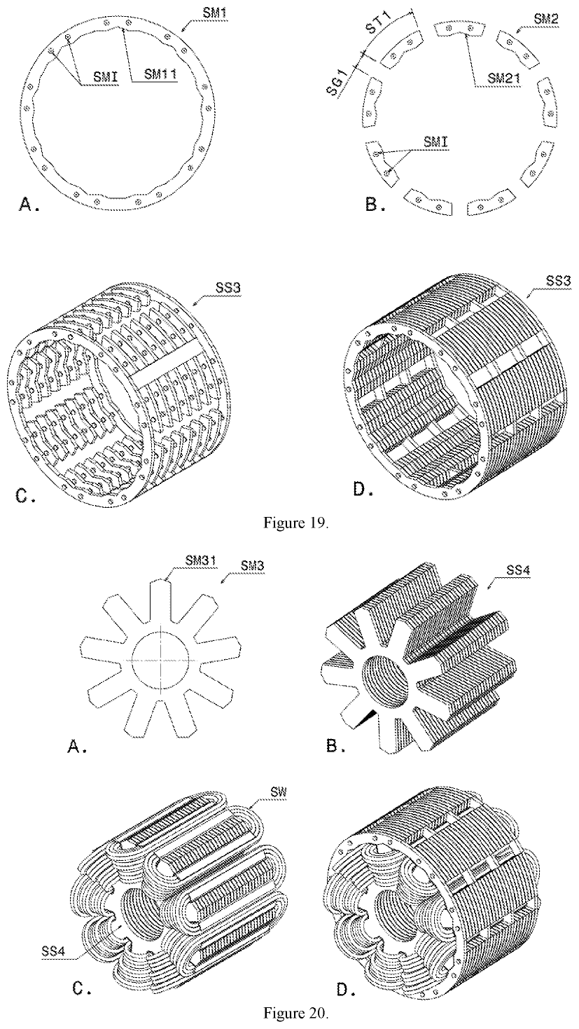

As mentioned above, stator windings of large motors should preferably be wound with a thick rigid wire. So it would be easier to use a split stator also in case of an external rotor. Assembly steps for an outer stack of a split stator are demonstrated in FIG. 19. In FIG. 19A a lamination SM1 with bridges between tooth shoes is shown. There are triangular slots SM11 on the inner surface of the lamination SM1 for further aligning on an internal stack. Also, a few impressions SM1 are provided for each tooth shoe. In FIG. 19B a set of tooth shoe laminations SM2 is shown. The width of the tooth shoes at the outer surface is equal to ST1 and the width of the space between tooth shoes at the outer surface in assembled outer stack is equal to SG1. Each lamination is also provided with impressions SM1. The tooth shoes SM2 also have a slot SM21 of a triangular shape equivalent to SM11 in FIG. 19A. In FIG. 19C a relative orientation of laminations SM1 and SM2 within the outer stack SS3 is shown. Impressions SM1 on the laminations SM1 and SM2 would help maintaining their relative position. Laminations SM1 provide mechanical integrity to the outer stack SS3. In order to avoid excessive flux leakage through bridges in SM1 laminations, these laminations could be cut from a non-magnetic material such as, for instance, austenitic stainless steel or another non-magnetic metal, while laminations SM2 could be made of a soft magnetic metal such as, for instance, electrical steel. In FIG. 19D a completed outer stack SS3 is shown. The stack SS3 could additionally be held together by welding. In FIG. 20A a lamination SM3 of an internal stack is shown. This lamination has tooth tops SM31 of a triangular shape corresponding to SM11 and SM21 demonstrated in FIG. 19A and FIG. 19B. In FIG. 20B a completed internal stack SS4 is shown. Then concentric stator windings SW could be wound and located on the teeth of the inner stack SS4, as shown in FIG. 20C. The inner stack SS4 with the stator winding SW could then be inserted into the outer stack SS3, as shown in FIG. 20D. The outer stack SS3 could be preheated prior to insertion of the inner stack SS4 with the stator winding SW.

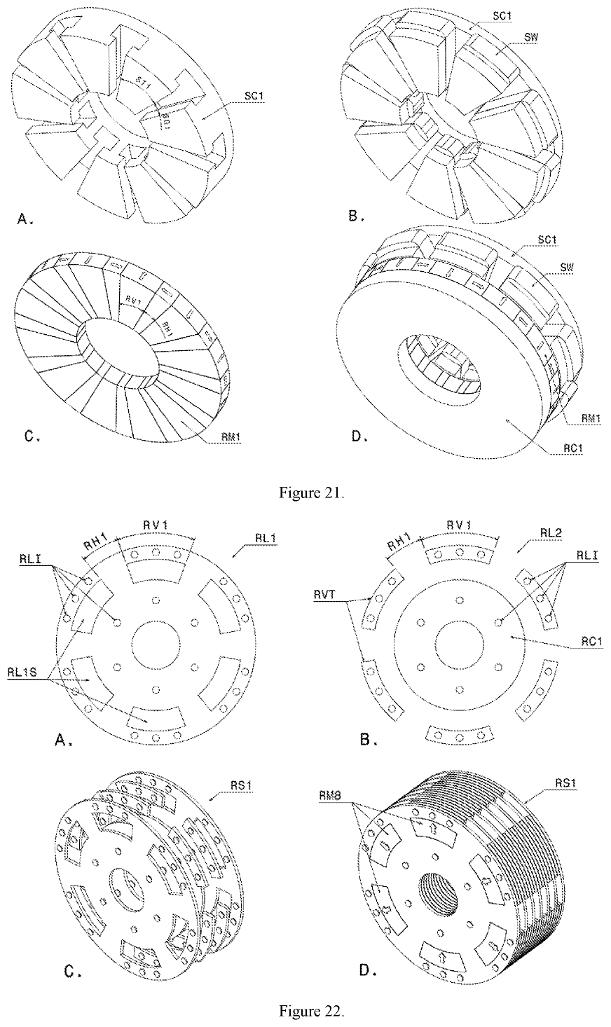

In FIG. 21 another example is presented of building active parts of electrical machines based on configurations shown in FIGS. 1-13. In FIG. 21 a structure of an axial electrical machine is shown built in accordance with the configuration of FIG. 1. In FIG. 21A a stator core SC1 is demonstrated. The width of the stator tooth shoes is identified as ST1. The width of the space between neighboring stator teeth is indicated as SG1. As mentioned earlier, for axial electric machines ST1 and SG1 define angles in mechanical or electrical degrees. So both the tooth shoes of the stator teeth and spacers between neighboring teeth constitute sectors. As mentioned above ST1=90 el. deg., SG1=30 el. deg. The core SC1 could be performed laminated and, for instance, manufactured by winding. It could also be made of a soft magnetic composite. In FIG. 21B concentric stator windings SW are located on the teeth of the core SC1. The rotor magnets form a continuous layer RM1 of a disk shape, as presented in FIG. 21C. Vertically or, as mentioned earlier for this case, axially magnetized rotor magnets have a width RV1. Horizontally or, for this case, tangentially magnetized magnets have a width of RH1. As mentioned above, for axial electric machines RV1 and RH1 define angles in mechanical or electrical degrees. So the rotor magnets constitute sectors such that RV1=60 el. deg. and RH1=30 el. deg. In FIG. 21D the active part of the axial machine is demonstrated. A rotor core RC1 is attached to the layer of magnets RM1.

As demonstrated earlier in FIG. 10, the proposed invention allows the use of an extension layer of extension blocks over rotor magnets. In FIG. 22 a structure of a 6 pole internal rotor for a radial electrical machine is shown with a discontinuous layer of vertically magnetized magnets and an extension layer of extension blocks of a soft magnetic material over the magnets. The rotor presented in FIG. 22 is in accordance with the rotor configuration demonstrated in FIG. 10. In FIG. 22A a lamination RL1 of a non-magnetic material with impressions RL1 is shown. The lamination RL1 contains slots RL1S for rotor magnets. The width of the slots RL1S is equal to RV1 and the space between slots is equal to RH1. In FIG. 22B a set RL2 of laminations of a soft magnetic material is shown comprising extension blocks RVT and a central lamination of a rotor core RC1. Extension blocks RVT have the width RV1 at the outer surface and the space between the extension blocks at the outer surface is equal to RH1. Laminations of the set RL2 are provided with impressions RL1 corresponding to the impressions of the lamination RL1. In FIG. 22C a relative location of laminations RL1 and RL2 in the rotor stack RS1 is presented. In FIG. 22D a complete rotor stack is shown with vertically magnetized magnets RM8 inserted into the corresponding slots. Laminations RL1 together with impressions RL1 provide mechanical integrity to the rotor structure. Since laminations RL1 are made of a non-magnetic material, there is no leakage of magnetic flux of the magnets through laminations RL1. So the rotor structure presented in FIG. 22D is capable of sustaining large centrifugal forces. Laminations RL1 are uniformly distributed within the rotor stack RS1. The mechanical strength of the rotor is determined by the proportion of laminations RL1 in the rotor stack.

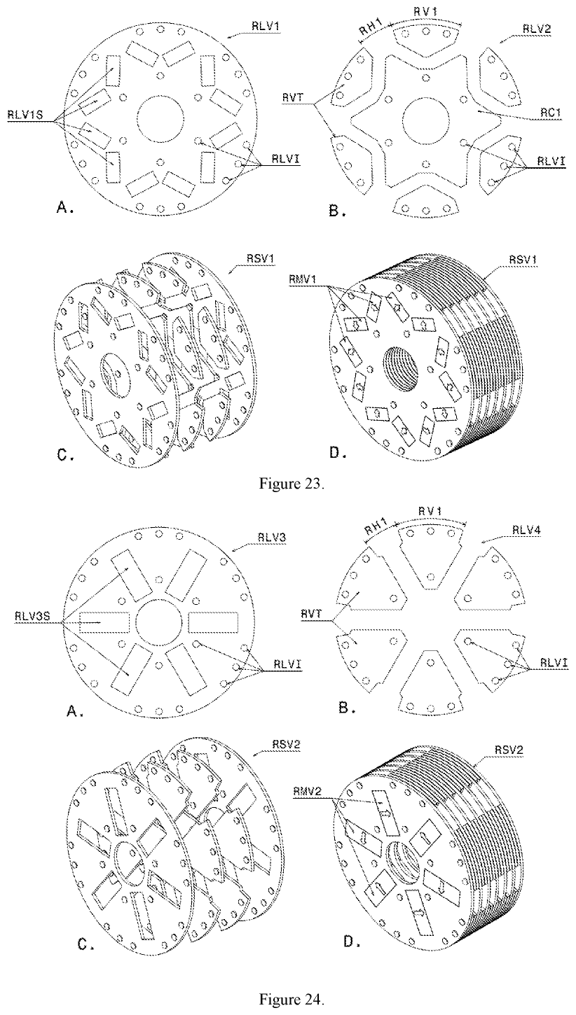

In FIG. 12 it was demonstrated that the rotor magnets RMV1 could take a V-shape and be located between extension blocks RVT and a rotor core RC1. In FIG. 23 a practical implementation of such a rotor configuration is shown. In FIG. 23A a lamination RLV1 of a non-magnetic material with impressions RLV1 is shown. The lamination RLV1 contains slots RLV1S for magnets. In FIG. 23B a set of laminations RLV2 of a soft magnetic material is shown composed of extension blocks RVT and a central lamination of the rotor stack RC1. Extension blocks RVT have the width of RV1 at the gap and the space between extension blocks at the gap is equal to RH1. Laminations of the set RLV2 are provided with impressions RLV1 corresponding to the impressions of the lamination RLV1. In FIG. 23C a relative location of laminations RLV1 and RLV2 in a rotor stack RSV1 is presented. In FIG. 23D a completed rotor stack RSV1 is shown with V-shape magnets RMV1. Laminations RLV1 together with impressions RLV1 provide mechanical integrity to the rotor structure. Since laminations RLV1 are made of a non-magnetic material, there is no leakage of magnetic flux of the magnets through laminations RLV1. This means that magnets RMV1 would be used very efficiently, which is particularly important for weak magnets. The V-shape of magnets RMV1 also allows achieving magnetic flux concentration in extension blocks RVT, which is also important in case of weak magnets. The rotor structure presented in FIG. 23D is capable of sustaining large centrifugal forces. Mechanical strength of the rotor is determined by the proportion of laminations RLV1 in the rotor stack.

In FIG. 13 it was demonstrated that the rotor could be composed of horizontally magnetized magnets RMV2 and extension blocks RVT. In FIG. 24 a practical implementation of such a rotor configuration is shown. In FIG. 24A a lamination RLV3 of a non-magnetic material with impressions RLV1 is shown. The lamination RLV3 contains slots RLV3S for magnets. In FIG. 24B a set RLV4 of extension blocks RVT of a soft magnetic material is shown. Extension blocks RVT have the width of RV1 at the gap and the space between the extension blocks at the gap is equal to RH1. Laminations of the set RLV4 are provided with impressions RLV1 corresponding to the impressions of the lamination RLV3. In FIG. 24C a relative location of laminations RLV3 and RLV4 in a rotor stack RSV2 is presented. In FIG. 24D a completed rotor stack RSV2 is shown with horizontally magnetized magnets RMV2. Laminations RLV3 together with impressions RLV1 provide mechanical integrity to the rotor structure. Since laminations RLV3 are made of a non-magnetic material, there is no leakage of magnetic flux of the magnets through laminations RLV3. This means that magnets RMV2 are used very efficiently in such a rotor configuration, which is particularly important for weak magnets. This configuration also allows achieving magnetic flux concentration in extension blocks RVT, which is also important in case of weak magnets. The rotor structure presented in FIG. 24D is capable of sustaining large centrifugal forces. Laminations RLV3 are uniformly distributed within the stack RSV2. Mechanical strength of the rotor is determined by the proportion of laminations RLV3 in the rotor stack RSV2.

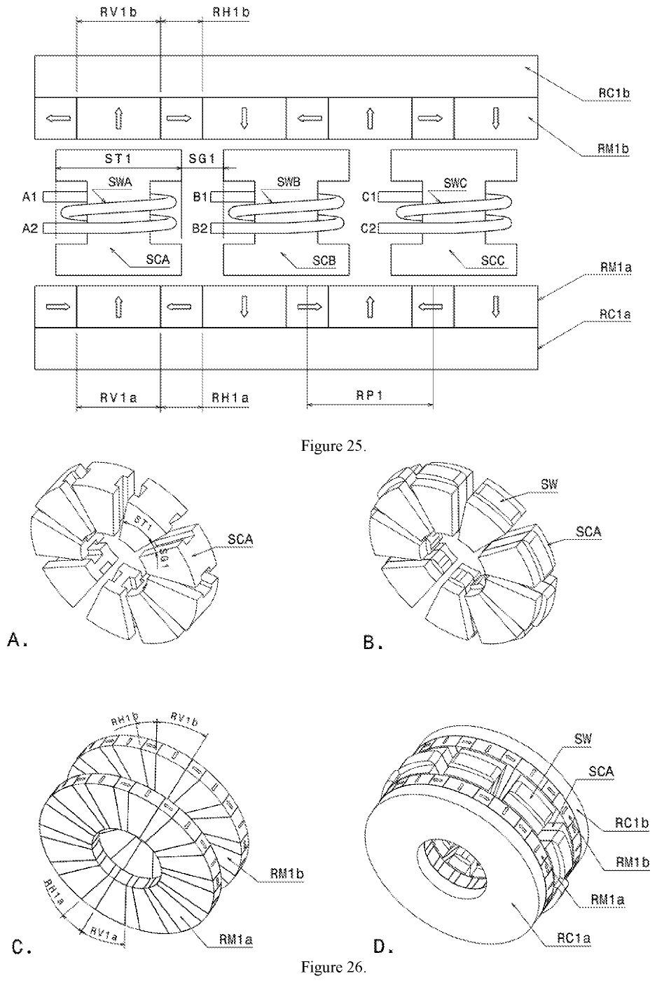

The proposed invention also allows the use of two rotors. A corresponding configuration of an active part of an electrical machine with two rotors is presented in FIG. 25. The stator is comprised of three separate teeth SCA, SCB and SCC. Each tooth carries a corresponding concentric winding and has two tooth shoes facing each rotor. The width of the tooth shoes is ST1. The space between tooth shoes is SG1. The rotors can be in accordance with any of configurations shown in FIGS. 1-15. In FIG. 25, as an example, the rotors correspond to the configuration of FIG. 1. Each rotor has a continuous layer of magnets facing the stator and indicated RM1a and RM1b respectively. Vertically magnetized magnets of the layer RM1a have the width RV1a and horizontally magnetized magnets have the width RH1a. Similarly, vertically magnetized magnets of the layer RM1b have the width RV1b and horizontally magnetized magnets have the width RH1b. Magnetization directions are indicated by arrows. So corresponding vertically magnetized magnets of the layers RM1a and RM1b have a parallel magnetization and horizontally magnetized magnets have anti parallel magnetization. The pole length on the rotors is RP1. In relation to the configuration shown in FIG. 25, RH1a=RH1b=RH1=0.5*RV1a=0.5*RV1b=0.5*RV1, RH1a+RV1a=RP1=ST1=3*SG1, RH1a=RH1b=SG1. Vertically magnetized magnets are aligned and have equal widths RV1a and RV1b. Horizontally magnetized magnets have anti parallel magnetization and equal widths RH1a and RH1b. Such an arrangement would be applicable for radial, axial and linear electrical machines.

In FIG. 26 a structure of the active part of an axial electrical machine is shown built in accordance with a configuration demonstrated in FIG. 25. In FIG. 26A a stator core is shown comprised of a set of teeth SCA. Tooth shoes have a width of ST1 and the space between neighboring teeth is SG1. In FIG. 26B a stator winding SW is located on the stator teeth. In FIG. 26C two layers of rotor magnets RM1a and RM1b are shown. The width of vertically, or in this case axially, magnetized magnets is RV1a and RV1b. The width of horizontally, or in this case tangentially, magnetized magnets is RH1a and RH1b respectively. As mentioned earlier, the dimensions ST1, SG1, RV1a, RV1b, RH1a, RH1b indicate the size of corresponding sectors in mechanical or electrical degrees. In FIG. 26 ST1=90 el. deg., SG1=30 el. deg., RV1a=RV1b=60 el. deg., RH1a=RH1b=30 el. deg. In FIG. 26D the active part of the axial machine is demonstrated. Rotor cores RC1a and RC1b are respectively attached to the layers of magnets RM1a and RM1b. Magnetic cores shown in FIG. 26A and in FIG. 26D could be made of laminations of a corresponding shape or by winding or from a soft magnetic composite.

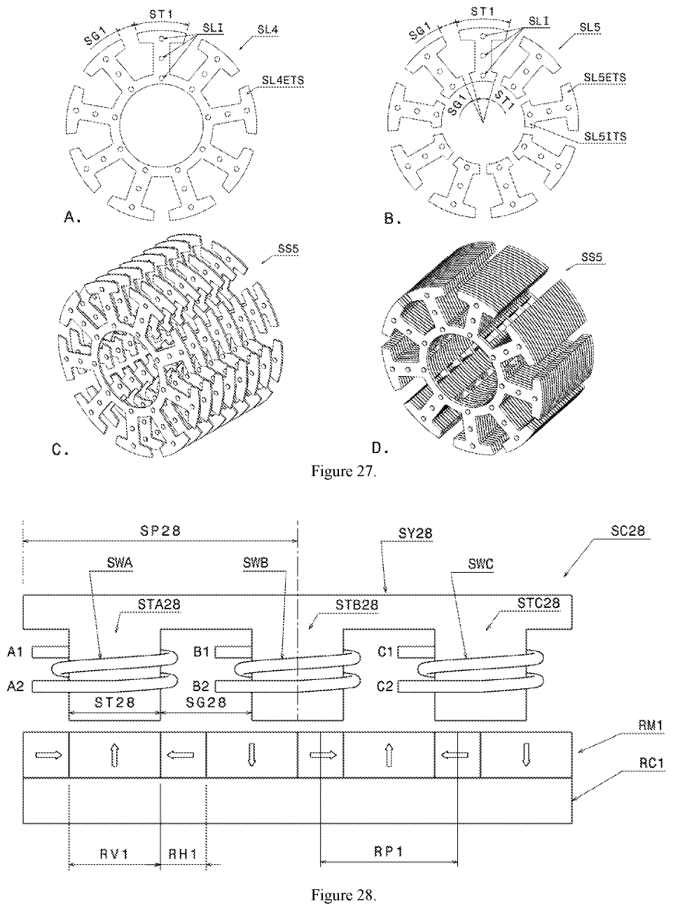

The configuration demonstrated in FIG. 25 is also applicable to radial electrical machines. In FIG. 27 a structure of a 6 pole stator for a radial electrical machine with two rotors is shown. In FIG. 27A a lamination SL4 with internal tooth shoes connected by bridges is presented. External tooth shoes SL4ETS are disconnected. The width of the external tooth shoes SL4ETS at the outer gap is equal to ST1. The width of the space between neighboring external tooth shoes SL4ETS at the outer gap is equal to SG1. The lamination SL4 is provided with impressions SL1. In FIG. 27B a set of laminations SL5 is presented. Laminations SL5 constitute separate stator teeth. The width of the external tooth shoes SL5ETS at the outer gap is equal to ST1. The width of the internal tooth shoes SL5ITS at the inner gap is also equal to ST1. The width of the space between neighboring external tooth shoes SL5ETS at the outer gap is equal to SG1. The width of the space between neighboring internal tooth shoes SL5ITS at the inner gap is also equal to SG1. The laminations SL5 are provided with a set of impressions SL1 corresponding to impressions SL1 on the lamination SL4 in FIG. 27A. In FIG. 27C a relative orientation of laminations SL4 and SL5 within a stator stack SS5 is shown. Impressions SL1 on the laminations SL4 and SL5 help maintaining their relative position. Laminations SL4 provide mechanical integrity to the stack SS5. In order to avoid excessive flux leakage through bridges in SL4 laminations, these laminations could be cut from a non-magnetic material such as, for instance, austenitic stainless steel or another non-magnetic metal, while laminations SL5 could be made of a soft magnetic metal such as, for instance, electrical steel. In FIG. 27D a completed stator stack SS5 is shown. Laminations SL4 are uniformly distributed within the stack SS5. The stack SS5 could additionally be held together by welding. After that a stator winding could be manufactured using the openings between external tooth shoes.

The proposed invention also allows the use of insertable coils of the stator winding. In this case it is preferable to have stator teeth with a constant cross section and without tooth shoes. A corresponding configuration of an active part of an electrical machine with straight stator teeth is presented in FIG. 28. The stator core SC28 is comprised of teeth STA28, STB28 and STC28 connected by yoke SY28. Each tooth carries a corresponding concentric winding SWA, SWB or SWC and has a uniform cross-section. The stator pole length is indicated as SP28. The width of the stator tooth at the gap with the rotor is ST28. The space between neighboring teeth is SG28. The rotor can be in accordance with any of configurations shown in FIGS. 1-15 and has magnetization described in paragraphs [0009]-[0010], [0012], [0014]-[0024]. In FIG. 28, as an example, the rotor corresponds to the configuration of FIG. 1. The width of the stator tooth must remain in the following range: SP28/4<=ST28<=SP28/2. And the space between neighboring teeth would be: SP28/6<=SG2<=5*SP28/12. This configuration has some advantages. The stator windings could be manufactured outside the stator with a high filling factor. This approach allows the use of thick rigid wires of possibly rectangular cross-section. After that prefabricated stator windings could be installed onto corresponding teeth of the stator core. In case of an electrical machine with an internal rotor in accordance with FIG. 28, stator windings on even and on uneven stator teeth could be different in shape.

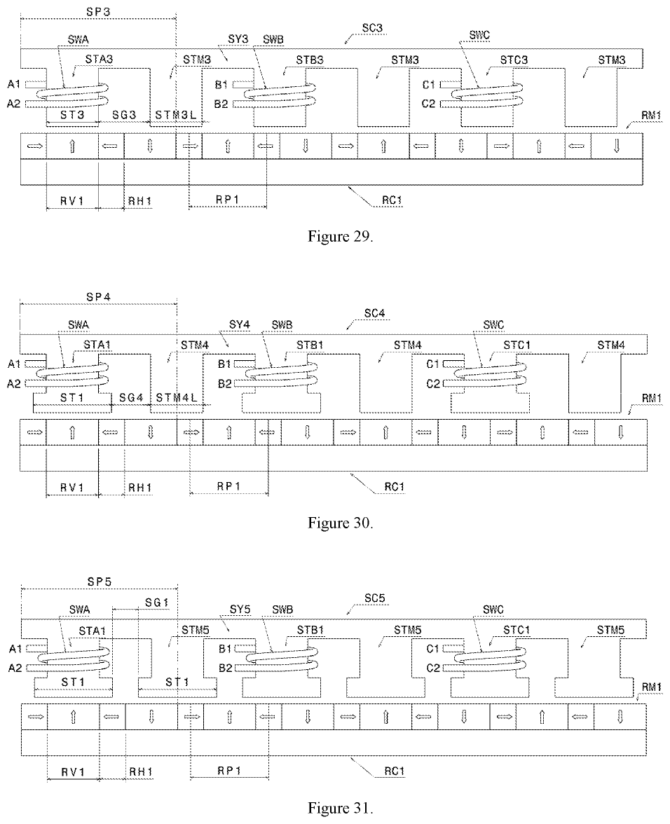

The proposed invention also allows that coils of the stator winding are located only on uneven teeth of the stator core. A corresponding configuration of an active part of an electrical machine with straight uneven stator teeth and coils of the stator winding located only on uneven teeth is shown in FIG. 29.

The stator core SC3 is composed of three straight uneven teeth STA3, STB3, STC3 and three even (or intermediate) teeth STM3 connected by yoke SY3. The teeth STA3, STB3 and STC3 carry stator windings SWA, SWB and SWC accordingly and have parallel walls, which means that these teeth do not have tooth shoes. Current of three phase winding, presented in FIG. 29, creates magnetic field having 4 poles. The stator pole length is indicated as SP3. The width of the stator teeth carrying windings at the gap with the rotor is ST3. The width of the space between neighboring teeth at the gap is SG3. The width of even (or intermediate) stator teeth STM3 at the gap is STM3L. The uneven teeth STA3, STB3 and STC3 will be also called further as teeth with coils. The number of coils of the stator winding is equal to (3/2)*p, where p is an even positive integer and defines the number of stator pole pairs. The even (or intermediate) teeth STM3 will be also called further as teeth without coils. The rotor can be in accordance with any of configurations shown in FIGS. 1-15. In FIG. 29, as an example, the rotor corresponds to the configuration of FIG. 1. The rotor has 8 poles. The pole length on the rotor is RP1, and RP1=SP3/2. As was clarified in paragraph [0009], the width of horizontally magnetized magnets RH1 can be in the following range: ⅙*RP1<=RH1<=⅔*RP1 or 1/12*SP3<=RH1<=⅓*SP3. The width of vertically magnetized magnets RV1 has a value in the following range: ½*RH1<=RV1<=5*RH1. The width of uneven stator teeth (or teeth with coils) must remain in the following range: SP3/4<=ST3<=SP3/2. The width of even (or intermediate) stator teeth (or teeth without coils) must remain in the following range: SP3/6<=STM3L<=SP3/2. The space between neighboring teeth SG3 will remain in the range: SP3/6<=SG3<−4/9*SP3. This configuration requires a fewer number of coils of the stator winding which could be produced outside the stator and installed on uneven stator teeth. This allows manufacturing stator windings of a very high quality with respect to achievable filling factor and insulation quality with fairly simple means. Also, a possibility of reducing the effective number of coils in the stator winding would simplify assembly and reduce the cost of electrical machine. In relation to the configuration shown in FIG. 29, where the width of horizontally magnetized magnets RH1 equals to ⅓*RP1, RH1=⅓*RP1, the width of stator teeth with winding ST3 equals to the width of vertically magnetized magnets RV1, ST3=RV1, where RV1=2*RH1 and RV1=⅔*RP1. In case of rotating electrical machines vertical walls of the horizontally magnetized magnets can have radial direction or can be parallel. According to paragraph [0010], SP3=3*RV1, therefore ST3=⅓*SP3.

The number of stator teeth Ns is defined as Ns=3*p, where p is the number of pole pairs of the stator and p is any even positive integer number. The number of stator poles Np1 is equal to 2*p and the number of rotor poles Np2 is equal to 4*p. The number of coils of the stator winding is equal to (3/2)*p. Thus, the number of stator teeth is a multiple of 6. For example, for p=2 the number of stator poles Np1 equals to 4, the number of stator teeth equals to 6, the number of coils of the stator winding equals to 3, the number of rotor poles Np2 equals to 8; for p=4 the number of stator poles Np1 equals to 8, the number of stator teeth equals to 12, the number of coils of the stator winding equals to 6, the number of rotor poles Np2 equals to 16; for p=6 the number of stator poles Np1 equals to 12, the number of stator teeth equals to 18, the number of coils of the stator winding equals to 9, the number of rotor poles Np2 equals to 24; and so on.

The proposed invention allows a combination of approaches shown in stators in FIG. 1 and in FIG. 29. A configuration with a combined stator is demonstrated in FIG. 30. The stator core SC4 is composed of three uneven teeth STA1, STB1, STC1 and three even (or intermediate) teeth STM4 connected by yoke SY4. The rotor can be in accordance with any of configurations shown in FIGS. 1-13. In FIG. 30, as an example, the rotor corresponds to the configuration of FIG. 1. The pole length on the rotor is RP1. The uneven teeth (or teeth with coils) STA1, STB1, STC1 carry corresponding stator windings and have tooth shoes with the width ST1 at the gap defined as ST1=RP1=0.5*SP4, where SP4 is the stator pole length. The width of even (or intermediate) teeth (or teeth without coils) at the gap is indicated as STM4L and defined by the range: SP4/6<=STM4L<=SP4/2. The length SG4 of space between neighboring teeth at the gap is defined by the following range: SP4/6<=SG4<=SP4/2. This configuration allows a reduced number of stator windings and good performance characteristics in electrical machines.

The proposed invention also allows that coils of the stator winding are located only on the uneven teeth of the stator core and all the stator teeth are provided with a tooth shoe as shown earlier in FIG. 1. This configuration is presented in FIG. 31. The stator core SC5 is composed of uneven teeth (or teeth with coils) STA1, STB1, STC1 and three even (or intermediate) teeth (or teeth without coils) STM5 connected by yoke SY5. The rotor can be in accordance with any of configurations shown in FIGS. 1-13. In FIG. 31, as an example, the rotor corresponds to the configuration of FIG. 1. The uneven teeth (or teeth with coils) STA1, STB1, STC1 carry corresponding stator windings and have tooth shoes with the width ST1 at the gap defined as ST1=RP1=0.5*SP5, where SP5 is the stator pole length. The width of even (or intermediate) teeth (or teeth without coils) STM5 at the gap is also equal to ST1. The length of space between neighboring teeth at the gap is equal to SG1, as defined above. This configuration also allows a reduced number of coils of the stator winding and good performance characteristics of electrical machines.

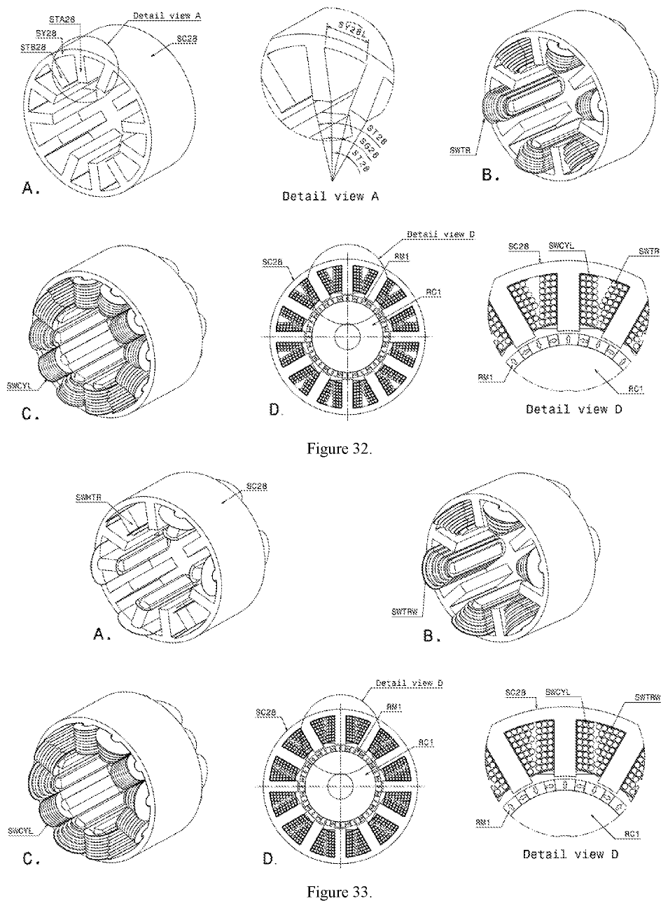

In FIG. 32 a radial rotating electrical machine with an internal rotor is shown with an active part in accordance with the configuration presented in FIG. 28. In FIG. 32A a stator core SC28 is shown. As mentioned above, in case of a radial electrical machine, dimensions introduced earlier for the configuration shown in FIG. 28 are defined as sectors and measured in mechanical or electrical degrees. The width of the stator teeth ST28 and the space between neighboring teeth SG28 are defined in mechanical or electrical degrees. The length of the yoke SY28 between two teeth is indicated as SY28L. The stator windings are installed in the stator core SC28 in two steps. The first step is shown in FIG. 32B. Stator windings SWTR of a trapezoidal shape are installed on the uneven stator teeth. In the next step demonstrated in FIG. 32C, stator windings SWCYL of a uniform shape or a uniform thickness are installed on the even stator teeth. Then the rotor is inserted into the stator. The rotor can be in accordance with any of configurations shown in FIGS. 1-15. In FIG. 32D, as an example, the rotor corresponds to the configuration of FIG. 1. In FIG. 32D a cross-section of the active part of the electrical machine is presented. This approach gives high filling factor for the stator slots and allows using prefabricated coils for the stator winding, which reduces the production cost and improves performance characteristics of the electrical machine.

Coils of the stator winding could be wound directly onto corresponding stator teeth. Such approach is typically applied for stators shown in FIG. 14 and in FIG. 15. Coils of the stator winding could also be manufactured outside the stator core and installed on corresponding stator teeth, as demonstrated in FIG. 32. The proposed invention allows a combination of these two approaches. In FIG. 33 a radial rotating electrical machine with an internal rotor is shown with an active part in accordance with the configuration presented in FIG. 28, but with two sets of coils of the stator winding wherein the first set of coils is wound on the uneven stator teeth and the second set of coils is subsequently installed on the even stator teeth. In FIG. 33A a stator core SC28 is shown with winding holders SWHTR installed on the uneven teeth. In FIG. 33B trapezoidal coils SWTRW of the stator winding are wound on the uneven teeth of the stator core. In FIG. 33C premanufactured coils with a uniform cross-section SWCYL of the stator winding are installed on the even teeth of the stator core. Then a rotor is inserted into the stator. The rotor can be in accordance with any of configurations shown in FIGS. 1-15. In FIG. 33D, as an example, the rotor corresponds to the configuration of FIG. 1. In FIG. 33D a cross-section of the active part of the machine is presented. This approach of two-step stator winding manufacturing and installation allows achieving the maximum possible filling factor for the stator slots. A controlled opening could be left between coils SWTRW and SWCYL of the stator winding for insulation or cooling. Such high filling factor in the stator slots would allow achieving very high efficiency of the machine.

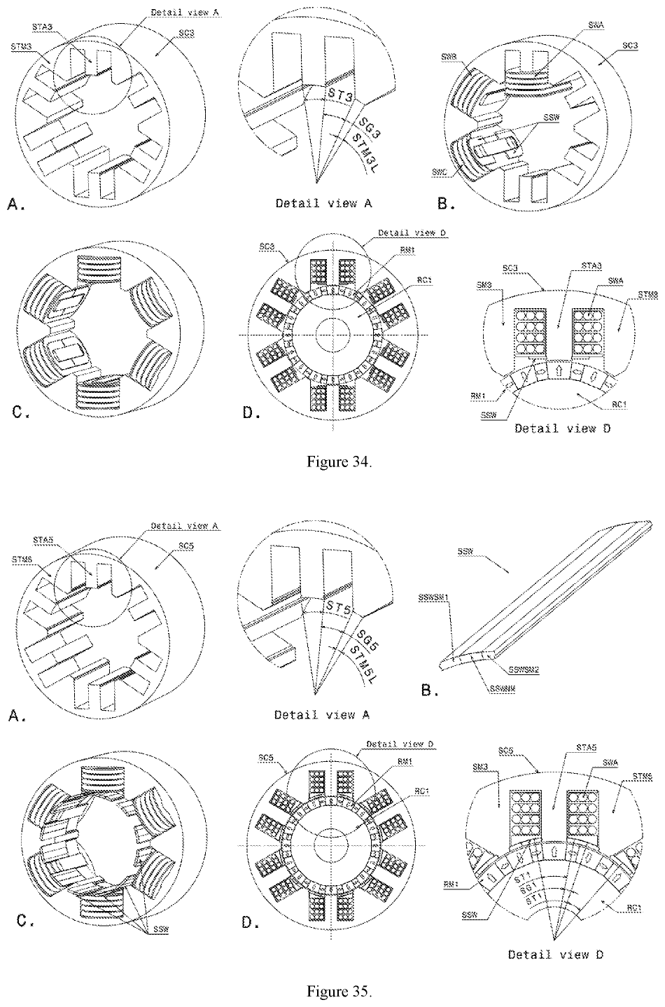

In FIG. 34 a radial rotating electrical machine with an internal rotor is shown with an active part in accordance with the configuration presented in FIG. 29. In FIG. 34A a stator core SC3 is presented. As mentioned above, in case of a radial electrical machine, dimensions introduced earlier for the configuration shown in FIG. 29 are defined as sectors and measured in mechanical or electrical degrees. The width ST3 at the gap of the uneven stator teeth carrying coils of the stator winding, the width STM3L of the even (or intermediate) stator teeth (or teeth without coils) at the gap and the space SG3 between neighboring teeth at the gap are considered as sectors and defined in mechanical or electrical degrees. In FIG. 34B the process of installation of coils of the stator winding is shown. The coils of the stator winding are installed on the uneven teeth of the stator core having a uniform cross-section. The coils are fixed on the stator core by inserting supporting wedges SSW into corresponding slots in the uneven teeth. A completed stator winding with all the coils installed is shown in FIG. 34C. The number of coils of the stator winding is equal to (3/2)*p, where p is an even positive integer and defines the number of stator pole pairs. Then a rotor is inserted into the stator. The rotor can be in accordance with any of configurations shown in FIGS. 1-15. In FIG. 34D, as an example, the rotor corresponds to the configuration of FIG. 1. In FIG. 34D a cross-section of the active part of the machine is presented. The tooth STA3 carries stator winding SWA and has parallel walls. This approach of stator winding manufacturing and installation gives a high number of poles in the machine with a relatively low number of coils in the stator winding. This approach also allows achieving a very high filling factor for the stator slots. Intermediate stator teeth STM3 have a variable cross section. This configuration gives reduced core losses and overall high efficiency of the machine.

In FIG. 35 a radial rotating electrical machine with an internal rotor is shown with an active part in accordance with the configuration presented in FIG. 31. In FIG. 35A a stator core SC5 is shown. As mentioned above, in case of a radial electrical machine, dimensions introduced earlier for the configuration shown in FIG. 31 are defined as sectors and measured in mechanical or electrical degrees. Similarly to FIG. 34, the width ST5 at the gap of the uneven stator teeth carrying coils of the stator winding, the width STM5L of the even (or intermediate) stator teeth (or teeth without coils) at the gap and the space SG5 between neighboring teeth are considered as sectors and defined in mechanical or electrical degrees. In FIG. 35B a structure of a composite stator slot wedge SSW is demonstrated. The wedge is composed of soft magnetic parts SSWSM1 and SSWSM2 and a non-magnetic part SSWNM. Such composite wedges could be manufactured, for instance, by sintering. In the sections SSWSM1 and SSWSM2 a soft magnetic powder of, for instance, an iron silicon alloy, could be used, while in the section SSMNM a non-magnetic powder of, for instance, austenitic stainless steel could be applied. After sintering this would provide a solid component. In FIG. 35C the coils of the stator winding are installed on the uneven stator teeth and the composite slot wedges SSW are being inserted. Then a rotor is inserted into the stator. The rotor can be in accordance with any of configurations shown in FIGS. 1-15. In FIG. 35D, as an example, the rotor corresponds to the configuration of FIG. 1. In FIG. 35D a cross-section of the active part of the machine is presented. The tooth STA5 carries stator winding SWA and has parallel walls. Composite slot wedges change magnetic configuration of the stator and give tooth shoes to the stator teeth. So the width of the tooth shoes becomes equal to ST1, as demonstrated in FIG. 35D, and the space between neighboring tooth shoes is determined by the width of the non-magnetic part SSWNM of the composite slot wedges and equals SG1. So, with the help of composite slot wedges the stator configuration is modified from a configuration shown in FIG. 29 into a configuration shown in FIG. 31. Yet, the coils of the stator winding remain insertable, which gives a high slot filling factor and reduced production costs. Similarly, composite slot wedges could be used on a configuration shown in FIG. 28 and modify it into a configuration presented in FIG. 1. Note that stator slots in FIG. 34 and in FIG. 35 have parallel walls in accordance with corresponding uneven teeth. Coils of electrical machines, described in FIG. 32 and in FIG. 33, can be also fixed with wedges.

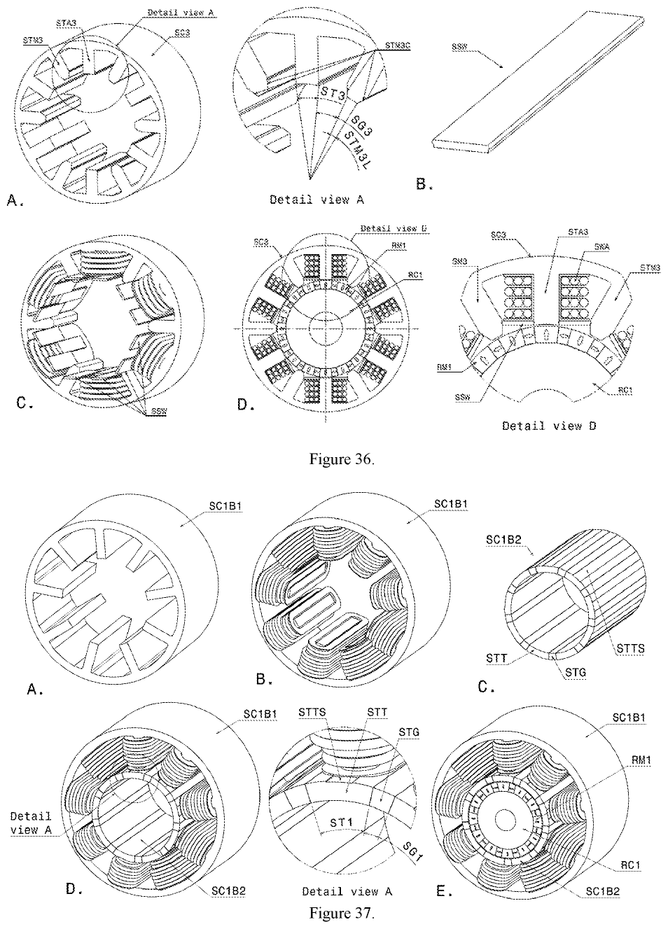

The proposed invention also allows the use of conventional non-magnetic slot wedges. In FIG. 36 a radial rotating electrical machine with an internal rotor is shown with an active part in accordance with the configuration presented in FIG. 29. In FIG. 36A a stator core SC3 is shown. As mentioned above, in case of a radial electrical machine, dimensions introduced earlier for the configuration shown in FIG. 29 are defined as sectors and measured in mechanical or electrical degrees. The width ST3 at the gap of the uneven stator teeth carrying coils of the stator winding, the width STM3L of the even (or intermediate) stator teeth (or teeth without coils) at the gap and the space SG3 between neighboring teeth at the gap are considered as sectors and defined in mechanical or electrical degrees. The even (or intermediate) stator teeth STM3, which do not have coils of the stator winding, have cuts STM3C close to the gap. The cuts STM3C are parallel to walls of corresponding uneven teeth. The remaining parts of the even teeth, extending from cuts STM3C to the stator yoke, have parallel walls. In this case the space for a coil of the stator winding can be increased. In FIG. 36B a configuration of a conventional non-magnetic slot wedge SSW is demonstrated. FIG. 36C shows the coils of the stator winding installed on the uneven teeth of the stator core having a uniform cross-section and slot wedges SSW being inserted. Then a rotor is inserted into the stator. The rotor can be in accordance with any of configurations shown in FIGS. 1-15. In FIG. 36D, as an example, the rotor corresponds to the configuration of FIG. 1. In FIG. 36D a cross-section of the active part of the machine is presented. The space between the winding SWA and the tooth STM3 can be used for a forced cooling with a cooling medium, for example, with air.

Magnetization of magnet segments shown in FIGS. 1-7, FIG. 14, FIG. 15, FIG. 18, FIG. 21, FIG. 25, FIG. 26, FIGS. 28-36 is known as Halbach magnetization, which is widely used in passive magnetic bearings and electrical machines. The novelty of the proposed invention is in providing relations between geometric dimensions of magnet segments and geometric dimensions of the tooth zone of the stator. These relations allow achieving higher electromagnetic torque, higher efficiency and lower cogging torque in electrical machines.

Configurations of active parts of electrical machines presented above are especially suitable for synchronous and BLDC machines. They imply that magnets are located on a rotating part and electric windings are positioned on the static part. However the same configurations could be applicable also for DC machines. In case of DC machines the magnets would have to be located on a static part and electric windings would have to be positioned on a rotating part. The static part is, in this case, called an inductor and the rotating part is called an armature. The relations established above are applicable for the size of magnets and dimensions of inductor teeth. These relations would allow achieving higher electromagnetic torque, higher efficiency and lower cogging torque.

A proportion of non-magnetic laminations in magnetic cores SS1 in FIG. 16, SS3 in FIG. 19, RS1 in FIG. 22, RSV1 in FIG. 23, RSV2 in FIG. 24, SS5 in FIG. 27 is in the range from 1% to 99% depending on requirement on mechanical strength and other operating conditions. For better distribution of mechanical strength, the non-magnetic laminations are uniformly distributed within corresponding cores.

A possible use of a removable part SC1B2 containing separate tooth shoes (FIG. 1B) for a rotating electrical machine with inner rotor is shown in FIG. 37. A stator part SC1B1, comprising a stator yoke and stator teeth, is presented in FIG. 37A. This part has axial length L1, which was mentioned in paragraph [0010] and demonstrated in FIG. 1B. The coils of the stator winding, which are manufactured outside the stator, are installed on the stator teeth (FIG. 37B). FIG. 37C shows a removable part SC1B2 composed of the tooth shoes STT preferably made of a soft magnetic composite and non-magnetic fixing parts STG, as explained in paragraph [0010]. Additionally, the tooth shoes STT have slots STTS. The part SC1B2 shown in FIG. 37C could be manufactured, for instance, in a mold by filling the space between tooth shoes STT with a non-magnetic metal or a plastic or a ceramic material. The removable part SC1B2 has the axial length LTS. The removable part SC1B2 is pressed into the stator part SC1B1 with the winding (FIG. 37D), so that the stator teeth slide into the slots STTS. The assembled active part of an electrical machine is presented on the FIG. 37E. Here the axial length LTS of the removable part SCIB2 equals to the axial length L2 of the layer of permanent magnets RM1 and rotor yoke RC1.

1. An electrical machine, which can be a radial, an axial or a linear, comprising a stator and a rotor separated by a non-magnetic gap, wherein the radial electrical machine can be with inner or with outer rotor, and wherein the electrical machine comprises the combination of properties:
a. the stator of the electrical machine comprises a core of a soft magnetic material with 3*p teeth connected by a yoke on the side opposite to the gap with a concentrated winding on each tooth, wherein the windings form a three phase system, wherein the teeth have a tooth shoe, and wherein current in the three phase winding creates magnetic field with 2*p poles, where p is any positive integer number and represents a number of stator pole pairs;
b. the rotor is composed of a core of a soft magnetic material and a set of permanent magnets and has 4*p magnetic poles and wherein:
1) the permanent magnets represent a layer, wherein the layer of permanent magnets on the rotor is composed of a set of vertically and horizontally magnetized pieces of magnets, and wherein the vertically and horizontally magnetized magnets are separated by vertical borders;
2) horizontally magnetized magnets have a width at the gap larger or equal to 1/12 of a pole division of the stator and less or equal to ⅓ of the pole division of the stator;
3) vertically magnetized magnets have a width at the gap larger or equal to ½ of the width at the gap of horizontally magnetized magnets and less or equal to 5 widths at the gap of horizontally magnetized magnets; and
4) the pole division of the rotor at the gap equals to the sum of the widths of a vertically magnetized magnet and a horizontally magnetized magnet;
c. a slot opening of the stator at the gap is larger or equal to ⅙ of a pole division of the rotor and is less or equal to ½ of the pole division of the rotor;
d. width of a tooth shoe of the stator at the gap equals to 4/3 of the pole division of the rotor minus slot opening of the stator;
e. wherein the width of tooth shoes of the stator at the gap, the slot opening of the stator at the gap, the width of the vertically magnetized magnets at the gap, the width of the horizontally magnetized magnets at the gap and the pole division of the rotor at the gap are measured in mechanical or electric degrees for the radial and axial electrical machines and in linear values in the linear electrical machines;
f. wherein the vertical magnetization direction in the vertically magnetized magnets corresponds to the radial direction in radial electrical machines and to the axial direction in axial electrical machines; and
g. wherein the horizontal magnetization direction in the horizontally magnetized magnets corresponds to the tangential direction in radial and in axial electrical machines.

2. An electrical machine, which can be a radial, an axial or a linear, comprising a stator and a rotor separated by a non-magnetic gap, wherein the radial electrical machine can be with inner or with outer rotor, and wherein the electrical machine comprises the combination of properties:
a. the stator of the electrical machine comprises a core of a soft magnetic material with 3*p teeth connected by a yoke on the side opposite to the gap with a concentrated winding on each tooth, wherein the windings form a three phase system, wherein the teeth have a tooth shoe, and wherein current in the three phase winding creates magnetic field with 2*p poles, where p is any positive integer number and represents a number of stator pole pairs;
b. the rotor is composed of a core of a soft magnetic material and a layer of permanent magnets and has 2*p magnetic poles and wherein:
1) the permanent magnets represent a layer, wherein the layer of permanent magnets on the rotor is composed of a set of vertically and horizontally magnetized pieces of magnets, and wherein the vertically and horizontally magnetized magnets are separated by vertical borders;
2) horizontally magnetized magnets have a width at the gap larger or equal to ⅙ of a pole division of the stator and less or equal to ⅔ of the pole division of the stator;
3) vertically magnetized magnets have a width at the gap larger or equal to ½ of the width at the gap of horizontally magnetized magnets and less or equal to 5 widths at the gap of horizontally magnetized magnets; and
4) the pole division of the rotor at the gap equals to the sum of the widths of a vertically magnetized magnet and a horizontally magnetized magnet;
c. a slot opening of the stator at the gap is less or equal to 1/12 of a pole division of the rotor and is less or equal to ¼ of the pole division of the rotor;
d. the width of a tooth shoe of the stator at the gap equals to ⅔ of the pole division of the rotor minus slot opening of the stator;
e. wherein the width of tooth shoes of the stator at the gap, the slot opening of the stator at the gap, the width of the vertically magnetized magnets at the gap, the width of the horizontally magnetized magnets at the gap and the pole division of the rotor at the gap are measured in electric degrees for the radial and axial electrical machines and in linear values in the linear electrical machines;
f. wherein the vertical magnetization direction in the vertically magnetized magnets corresponds to the radial direction in radial electrical machines and to the axial direction in axial electrical machines; and
g. wherein the horizontal magnetization direction in the horizontally magnetized magnets corresponds to the tangential direction in radial and in axial electrical machines.

3. An electrical machine, which can be a radial, an axial or a linear, comprising a stator and a rotor separated by a non-magnetic gap, wherein the radial electrical machine can be with inner or with outer rotor, and wherein the electrical machine comprises the combination of properties:
a. the stator of the electrical machine comprises a core of a soft magnetic material with 3*p teeth connected by a yoke on the side opposite to the gap, with a concentrated winding on each uneven tooth, which is called a tooth with a coil, wherein the windings form a three phase system and wherein the number of coils of the stator winding equals to (3/2)*p, wherein teeth with coils have parallel walls, and wherein current in the three phase winding creates magnetic field with 2*p poles, where p is any even positive integer number and represents a number of stator pole pairs and wherein the width of each tooth with a coil at the gap is larger or equal to ¼ of the pole division of the stator and less or equal to ½ of the pole division of the stator and wherein the width of each even tooth at the gap is larger or equal to ⅙ of the pole division of the stator and less or equal to ½ of the pole division of the stator;
b. the rotor is composed of a core of a soft magnetic material and a set of permanent magnets and has 4*p magnetic poles and wherein:
1) the permanent magnets represent a layer, wherein the layer of permanent magnets on the rotor is composed of a set of vertically and horizontally magnetized pieces of magnets, and wherein the vertically and horizontally magnetized magnets are separated by vertical borders;
2) horizontally magnetized magnets have a width at the gap larger or equal to 1/12 of a pole division of the stator and less or equal to ⅓ of a pole division of the stator;
3) vertically magnetized magnets have a width at the gap larger or equal to ½ of the of the width at the gap of horizontally magnetized magnets and less or equal to 5 of the widths at the gap of horizontally magnetized magnets; and
4) the pole division of the rotor at the gap equals the sum of the widths of a vertically magnetized magnet and a horizontally magnetized magnet;
c. wherein the width of stator teeth at the gap, the width of the vertically magnetized magnets at the gap, the width of the horizontally magnetized magnets at the gap and the pole division of the rotor at the gap are measured in mechanical or electric degrees for the radial and axial electrical machines and in linear values in the linear electrical machines;
d. wherein the vertical magnetization direction in the vertically magnetized magnets corresponds to the radial direction in radial electrical machines and to the axial direction in axial electrical machines; and
e. wherein the horizontal magnetization direction in the horizontally magnetized magnets corresponds to the tangential direction in radial and in axial electrical machines.

4. The electrical machine according to claim 1, wherein:
a. horizontally magnetized magnets have the width at the gap of ⅓ of the pole division of the rotor;
b. vertically magnetized magnets have the width at the gap, which equals to double width of horizontally magnetized magnets at the gap;
c. the pole division of the rotor at the gap equals the sum of the widths of a vertically magnetized magnet and a horizontally magnetized magnet;
d. the width of the tooth shoe of the stator at the gap equals the pole division of the rotor; and
e. the slot opening of the stator at the gap equals to the width of the horizontally magnetized magnet at the gap.

5. The electrical machine according to claim 2, wherein:
a. horizontally magnetized magnets have the width at the gap of ⅓ of the pole division of the rotor;
b. vertically magnetized magnets have the width at the gap, which equals to double width of horizontally magnetized magnets at the gap;
c. the pole division of the rotor at the gap equals the sum of the widths of a vertically magnetized magnet and a horizontally magnetized magnet;
d. the width of the tooth shoe of the stator at the gap equals to ½ of the pole division of the rotor; and
e. the slot opening of the stator at the gap equals to ½ of the width of the horizontally magnetized magnet at the gap.

6. The electrical machine according to claim 3, wherein:
a. horizontally magnetized magnets have the width at the gap of ⅓ of the pole division of the rotor;
b. vertically magnetized magnets have the width at the gap, which equals to double width of horizontally magnetized magnets at the gap;
c. the pole division of the rotor at the gap equals to the sum of the widths of a vertically magnetized magnet and a horizontally magnetized magnet; and
d. the width of the stator teeth at the gap equals to the width of vertically magnetized magnets of the rotor.

7. The electrical machine according to the claims from 1 to 2 and from 4 to 5, wherein the electrical machine comprises two rotors separated by two non-magnetic gaps wherein stator teeth are separate parts containing tooth shoes at each gap.

8. The electrical machine according to the claims from 1 to 3, wherein the vertically magnetized magnets and horizontally magnetized magnets have a triangular shape, wherein the width of vertically magnetized magnets at the gap equals the pole length of the rotor and the width of horizontally magnetized magnets at the rotor core equals the pole length of the rotor.

9. The electrical machine according to the claim from 1 to 3, wherein the layer of permanent magnets is composed of separate pieces or represents a solid body, and wherein permanent magnets have polar magnetization.

10. The electrical machine according to the claim 9, wherein the width of the tooth shoe of the stator at the gap equals to the pole division of the rotor.

11. The electrical machine according to the claims from 1 to 3, wherein the layer of permanent magnets represents separate pieces of vertically magnetized magnets and wherein:
a. the width of vertically magnetized magnets at the gap is in the range from ⅔ of pole length of the rotor to the pole length of the rotor; and
b. the width of space between magnets at the gap RG1 is in the range from 0 to ⅓ of pole length of the rotor.

12. The electrical machine according to the claim 11, wherein the width of the space between neighboring magnets changes from RG1 at the gap to zero at the surface of the rotor yoke.

13. The electrical machine according to the claims 11 and 12, wherein the layer of permanent magnets represents separate pieces of vertically magnetized magnets and wherein there is a layer of extension blocks of a soft magnetic material over the rotor magnets.

14. The electrical machine according to the claims from 1 to 3, wherein permanent magnets represent separate pieces and are located in a V-shape and wherein there is a layer of extension blocks of a soft magnetic material over the rotor magnets and wherein the width of extension blocks at the gap is equal to ⅔ of the rotor pole length and the space between extension blocks at the gap is equal to ⅓ of the rotor pole length.

15. The electrical machine according to the claims from 11 to 14, wherein the rotor stack is composed of two types of laminations:
a. a lamination of a non-magnetic material with slots for magnets and a set of impressions; and
b. a set of laminations of a soft magnetic material with impressions corresponding to impressions on the lamination of the non-magnetic material, comprising:
1) laminations defining extension blocks; and
2) laminations defining the rotor core;
wherein laminations of the rotor stack are connected by impressions, the proportion of the non-magnetic laminations in the rotor stack is from 1% to 99%, the non-magnetic laminations are uniformly distributed within the rotor stack, and wherein the magnets are inserted into corresponding slots in the stack.

16. The electrical machine according to the claims from 1 to 3 and 7, wherein the layer of permanent magnets represents separate pieces of horizontally magnetized magnets and wherein there are extension blocks of a soft magnetic material between the rotor magnets and wherein the width of extension blocks at the gap is equal to ⅔ of the rotor pole length and the space between extension blocks at the gap is equal to ⅓ of the rotor pole length.

17. The electrical machine according to the claim 16, wherein the rotor stack is composed of two types of laminations:
a. a lamination of a non-magnetic material with slots for magnets and a set of impressions; and
b. a set of laminations of a soft magnetic material defining extension blocks with impressions corresponding to impressions on the lamination of the non-magnetic material;
wherein the laminations of the rotor stack are connected by impressions, the proportion of the non-magnetic laminations in the rotor stack is from 1% to 99%, the non-magnetic laminations are uniformly distributed within the rotor stack, and wherein the magnets are inserted into corresponding slots in the stack.

18. The radial electrical machine with inner rotor according to the claims 1 and 2, and according to the claims from 8 to 17, wherein:
a. the stator core is comprised of an inner stack and a separate stator yoke stack wherein:
1) the inner stack is assembled of soft magnetic laminations and non-magnetic laminations, wherein:
a) soft magnetic laminations have a shape of stator teeth with tooth shoes and contain impressions;
b) non-magnetic laminations have a shape of stator teeth with tooth shoes connected by continuous bridges and wherein non-magnetic laminations contain impressions on the same locations as in soft magnetic laminations;
c) wherein the laminations of the inner stack are connected by impressions and wherein the proportion of the non-magnetic laminations in the internal stack is from 1% to 99% and wherein the non-magnetic laminations are uniformly distributed within the internal stack; and
2) the stator yoke stack is assembled of soft magnetic laminations of a ring shape;
b. the coils of the stator winding are placed on the teeth of the inner stack, if the coils are premanufactured outside the stator, or wound directly on the teeth of the inner stack; and
c. wherein the stator yoke is installed onto the inner stack with the stator winding.

19. The radial electrical machine with outer rotor according to the claims 1 and 2, and according to the claims from 8 to 18, wherein:
a. the stator core is comprised of an inner stack and a separate outer stack wherein
1) the inner stack is assembled of soft magnetic laminations of a shape of teeth connected by yoke; and
2) the outer stack has a shape of a ring and is assembled of soft magnetic laminations and non-magnetic laminations, wherein
a) soft magnetic laminations have a shape of stator tooth shoes and contain impressions; and
b) non-magnetic laminations have a shape of a ring composed of tooth shoes connected by continuous bridges and contain impressions on the same locations as in soft magnetic laminations;
wherein the laminations of the outer stack are connected by impressions and wherein the proportion of the non-magnetic laminations in the outer stack is from 1% to 99% and wherein the non-magnetic laminations are uniformly distributed within the outer stack; and
b. the coils of the stator winding are placed on the teeth of the inner stack, if the coils are premanufactured outside the stator, or wound directly on the teeth of the inner stack; and
c. wherein the outer stack is installed onto the inner stack with the stator winding.

20. The electrical machine in accordance with the claims 3 and 6, wherein the coils of the stator winding are located on each stator tooth and wherein p is a positive integer number.

21. The radial electrical machine with an internal rotor in accordance with the claim 20, wherein coils of the stator winding of a trapezoidal shape are installed or wound on the uneven stator teeth and coils of the stator winding with a uniform thickness are installed on the even stator teeth.

22. The radial electrical machine with an internal rotor in accordance with the claims 3 and 6, wherein the even stator teeth, which do not have coils of the stator winding, have cuts parallel to walls of corresponding uneven teeth at the gap, and the remaining parts of the even teeth extending from these cuts to the stator yoke, have parallel walls.

23. The radial electrical machine with an internal rotor in accordance with the claim 22, wherein vertical walls of the horizontally magnetized magnets have radial direction or the horizontally magnetized magnets have parallel walls.

24. The radial electrical machine with an internal rotor in accordance with the claim 22, wherein space between windings and teeth without coils is used for a cooling by a forced flow of cooling medium.

25. The radial electrical machine with internal rotor in accordance with the claims 3 and 6, wherein stator slots have parallel walls.

26. The radial electrical machine with an internal rotor in accordance with the claims from 1 to 6, wherein the horizontally magnetized magnets have parallel walls.

27. The electrical machine in accordance with the claim 3, and claims from 20 to 25, wherein the coils of the stator winding are fixed in the slots using slot wedges.

28. The electrical machine in accordance with the claim 27, wherein the slot wedge is composed of a non-magnetic section and two soft magnetic sections around the non-magnetic section.

29. The electrical machine in accordance with the claim 27, wherein the slot wedge is made of a non-magnetic material.

30. The DC electrical machine in accordance with any of the previous claims wherein the rotor according to the previous claims is used as an inductor and wherein the stator with the stator winding according to the previous claims is used as an armature.

31. The electrical machine in accordance with the claims 1 and 2, wherein the stator core comprises two parts: the first part of the stator core includes a stator yoke and stator teeth, and the second part of the stator core is a removable part, wherein the removable part comprises of tooth shoes and of fixing parts, wherein:
a. the tooth shoes and the fixing parts provide together the removable part as a solid body;
b. the tooth shoes of the removable part are made of a soft magnetic composite;
c. the fixing parts of the removable part are made of a non-magnetic material;
d. axial length of the removable part is in the range from axial length of stator teeth to 3 axial lengths of stator teeth;
e. axial length of the permanent magnets is in the range from axial length of stator teeth to 3.5 axial lengths of stator teeth; and
f. height of the removable part is selected based on a condition that the maximal flux density in the tooth shoes is less or equal to the knee point of the magnetization characteristic of the selected soft magnetic composite.
